(19) United States
(12) Patent Application Publication
(10) Pub. No.: US 2010/0270058 A1
(43) Pub. Date: Oct. 28, 2010

(54) METHODS FOR MAKING ELECTRONIC DEVICES

(75) Inventors: Wayne S. Mahoney, St. Paul, MN (US); Manoj Nirmal, St. Paul, MN (US); Jane K. Wardhana, St. Paul, MN (US); Matthew S. Stay, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/746,857

(22) PCT Filed: Dec. 8, 2008
(86) PCT No.: PCT/US08/85806

§ 371 Date: Jun. 8, 2010

Related U.S. Application Data
(60) Provisional application No. 61/013,690, filed on Dec. 14, 2007.

(51) Int. Cl. B05D 5/12; H05K 1/00

(52) U.S. Cl. 174/250; 427/58

(57) ABSTRACT

The present disclosure describes methods for making an electronic device. Methods for making electronic devices include providing a first electrode, an electro-responsive layer, and a second electrode. A first conductive nanostructured grid is deposited on a surface of the first electrode. The electro-responsive layer is facing the first conductive nanostructured grid. The electro-responsive layer is positioned between the first electrode and the second electrode. An electronic device having a first nanostructured grid deposited on a first electrode is described.

### FIELD

The present disclosure relates to electronic devices and methods of making such electronic devices.

### BACKGROUND

Patterned layers of functional materials can be used in electric component manufacture as well as in other applications. For example, multiple layers of patterned materials may be used in the manufacture of flat panel displays, such as liquid crystal displays. Active matrix liquid crystal displays include a plurality of rows and columns of address lines that cross at an angle to one another and form a plurality of crossover points. Techniques for applying patterned layers continue to evolve as the need increases for smaller structures in electric components.

Lithographic techniques, for example, can be used to generate small structures. However, as the size domain approaches the nanometer-sized dimensions, technical challenges arise that can limit using lithographic techniques for nanostructures.

Self-assembly is another method that can be used to construct small structures. Molecular self-assembly is referred to as the assembly of molecules without guidance or management from an outside source. Many biological systems use self-assembly to assemble various molecules and structures such as the lipid bilayer membrane in cells.

As the development of electronic components continues to approach smaller scales, the importance of continuity between adjoining or adjacent elements becomes increasingly important. Imperfections such as cracking, fractures, and voids in materials useful for manufacturing these components may result in electronic component failure or reduced performance.

### SUMMARY

The present disclosure describes methods for making an electronic device. Methods for making an electronic device comprising a first electrode, a first conductive nanostructured grid, an electro-responsive layer, and a second electrode are described. The first conductive nanostructured grid is deposited on a surface of the first electrode. The electro-responsive layer is positioned between the first electrode and the second electrode.

In a first aspect, a method is provided for making an electronic device. The method includes providing a first electrode, an electro-responsive layer, and a second electrode. A first conductive nanostructured grid is deposited on a surface of the first electrode. The first conductive nanostructured grid can be prepared by applying a coating composition in a coating direction to the surface of the first electrode to form a chromonic layer. The coating composition comprises chromonic material, surface modified inorganic nanoparticles, and water. A portion of the water is removed from the chromonic layer to form a dried chromonic layer. The dried chromonic layer is exposed to a hydrophilic organic solvent to form a channel pattern within the dried chromonic layer. The channel pattern comprises a first set of channels in the coating direction, and a second set of channels that are substantially perpendicular to the first set of channels. A metal containing material is disposed on a surface of the dried chromonic layer, and within both the first set of channels and the second set of channels. The metal containing material within the first set of channels and the second set of channels contacts the first electrode. The dried chromonic layer and the metal containing material disposed on the dried chromonic layer are removed. The metal containing material disposed within the first set of channels and the second set of channels adheres to the first electrode. The electro-responsive layer is provided facing the first conductive nanostructured grid. The electro-responsive layer is positioned between the first electrode and the second electrode.

In a second aspect, a method is provided for making an electronic device. The method includes providing a first electrode, an electro-responsive layer, and a second electrode. A first conductive nanostructured grid is deposited on a surface of the first electrode. The first conductive nanostructured grid comprises a first set of conductive nanostructures and a second set of conductive nanostructures substantially perpendicular to the first set of conductive nanostructures. The electro-responsive layer is provided facing the first conductive nanostructured grid. The electro-responsive layer is positioned between the first electrode and the second electrode.

In a third aspect, an electronic device is provided. The electronic device comprises a first electrode, a first conductive nanostructured grid deposited on a surface of the first electrode, an electro-responsive layer, and a second electrode. The first conductive nanostructured grid comprises a first set of conductive nanostructures and a second set of conductive nanostructures, such that the second set of conductive nanostructures is substantially perpendicular to the first set of conductive nanostructures. The electro-responsive layer faces the first conductive nanostructured grid. The electro-responsive layer is positioned between the first electrode and the second electrode.

In a fourth aspect, a method is provided for making an electronic device. The method includes providing a substrate, an electro-responsive layer, and a second electrode. A first conductive nanostructured grid is deposited on a surface of the substrate. The first conductive nanostructured grid can be prepared by applying a coating composition in a coating direction to the surface of the substrate to form a chromonic layer. The coating composition comprises chromonic material, surface modified inorganic nanoparticles, and water. A portion of the water is removed from the chromonic layer to from a dried chromonic layer. The dried chromonic layer is exposed to a hydrophilic organic solvent to form a channel pattern within the dried chromonic layer. The channel pattern comprises a first set of channels in the coating direction, and a second set of channels that are substantially perpendicular to the first set of channels. A metal containing material is disposed on a surface of the dried chromonic layer, and within both the first set of channels and the second set of channels. The metal containing material within the first set of channels and the second set of channels contacts the substrate. The dried chromonic layer and the metal containing material disposed on the dried chromonic layer are removed. The metal containing material disposed within the first set of channels and the second set of channels adheres to the substrate. The method includes depositing a conductive layer on the first conductive nanostructured grid and the surface of the substrate for forming a first electrode structure. The first electrode structure comprises the substrate having a first conductive nanostructured grid deposited on the surface of the substrate, and a conductive layer deposited on the first conductive nanostructured grid and on the surface of the substrate. The electro-responsive layer is provided facing the conductive layer of the first electrode structure. The electro-responsive layer is positioned between the first electrode structure and the second electrode.

In a fifth aspect, a method is provided for making an electronic device. The method includes providing a substrate, an electro-responsive layer, and a second electrode. A first conductive nanostructured grid is deposited on a surface of the substrate. The first conductive nanostructured grid comprises a first set of conductive nanostructures and a second set of conductive nanostructures substantially perpendicular to the first set of conductive nanostructures. The method includes depositing a conductive layer on the first conductive nanostructured grid and on the surface of the substrate for forming a first electrode structure. The first electrode structure comprises the substrate having a first conductive nanostructured grid deposited on the surface of the substrate, and a conductive layer deposited on the first conductive nanostructured grid and on the surface of the substrate. The electro-responsive layer is provided facing the conductive layer of the first electrode structure. The electro-responsive layer is positioned between the first electrode structure and the second electrode.

In a sixth aspect, an electronic device is provided. The electronic device comprises a substrate, a first conductive nanostructured grid deposited on a surface of the substrate, a conductive layer deposited on the first conductive nanostructured grid and the surface of the substrate, an electro-responsive layer, and a second electrode. The first conductive nanostructured grid comprises a first set of conductive nanostructures and a second set of conductive nanostructures, such that the second set of conductive nanostructures is substantially perpendicular to the first set of conductive nanostructures. The first electrode structure comprises the substrate having a first conductive nanostructured grid deposited on the surface of the substrate, and a conductive layer deposited on the first conductive nanostructured grid and on the surface of the substrate. The electro-responsive layer faces the conductive layer of the first electrode structure. The electro-responsive layer is positioned between the first electrode and the second electrode.

### BRIEF DESCRIPTION OF THE DRAWINGS

FIG. 1 is an optical micrograph (500× magnification) of a dried chromonic layer having a channel pattern of Example 1.

FIG. 2 is an optical micrograph (500× magnification) of a conductive nanostructured grid of Example 1.

FIG. 3 is a schematic representation of an electronic device.

FIG. 4 is a schematic representation of an electronic device containing a first electrode structure.

FIG. 5 is a schematic representation of a pixilated substrate.

### DETAILED DESCRIPTION

For the following defined terms, these definitions shall be applied, unless a different definition is given in the claims or elsewhere in the specification.

The term “nanostructured grid” refers to a conductive material having a pattern of horizontal and vertical nanostructures.

The term “chromonic material” or “chromonic compound” refers to a multi-ring molecule typically characterized by the presence of a hydrophobic core surrounded by various hydrophilic groups as described, for example, in Attwood, T. K., and Lydon, T. E., Molec. Crystals. Liq. Crystals, 108, 349 (1984). The hydrophobic core can contain aromatic rings, non-aromatic rings, or combinations thereof. When in solution, the chromonic materials tend to aggregate into a nematic ordering characterized by long-range order.

The term “nanostructure” refers to a structure having a height and a width that is generally less than 1 micrometer.

The term “nanoparticle” will generally refer to particles, groups of particles, particulate molecules (i.e., small individual groups of loosely associated groups of molecules) and groups of particulate molecules that while potentially varied in specific geometric shape have an effective, or average, diameter that is less than 1 micrometer.

The term “surface modified inorganic nanoparticle” refers to an inorganic particle that includes surface groups attached to the surface of the particle.

The term “substantially perpendicular” refers to an orthogonal or nearly orthogonal line no greater than 20 degrees, no greater than 15 degrees, no greater than 10 degrees, no greater than 5 degrees, no greater than 4 degrees, no greater than 2 degrees, or no greater than 1 degree from a perpendicular direction of 90 degrees. For example, a “substantially perpendicular” line may be in the range of 80 to 100 degrees, 82 to 98 degrees, 85 to 95 degrees, 88 to 92 degrees, or 89 to 91 degrees relative to a reference line.

The term “electrode” refers to an electrical conductor.

The term “electro-responsive layer” refers to a material that undergoes an optical, physical, electronic, or chemical change in the presence of an external electrical current or an external electrical field.

The recitation of numerical ranges by endpoints includes all numbers subsumed within that range (e.g., 1 to 5 includes 1, 1.5, 2, 2.75, 3, 3.8, 4, and 5).

As included in this specification and the appended claims, the singular forms “a”, “an”, and “the” include plural referents unless the content clearly dictates otherwise. Thus, for example, reference to a composition containing “a compound” includes a mixture of two or more compounds. As used in this specification and appended claims, the term “or” is generally employed in its sense including “and/or” unless the content clearly dictates otherwise.

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains errors necessarily resulting from the standard deviations found in their respective testing measurements.

The present disclosure describes a method of making an electronic device. The method includes providing a first electrode, an electro-responsive layer, and a second electrode. The method includes depositing a first conductive nanostructured grid on a surface of the first electrode. The electro-responsive layer faces the first conductive nanostructured grid. The electro-responsive layer is positioned between the first electrode and the second electrode.

In one aspect, a method is provided for making an electronic device. The method includes providing a first electrode, depositing a first conductive nanostructured grid on a surface of a first electrode, providing an electro-responsive layer, providing a second electrode, and positioning the electro-responsive layer between the first electrode and the second electrode. The electro-responsive layer is provided facing the first conductive nanostructured grid. The first conductive nanostructured grid comprises a first set of conductive nanostructures and a second set of nanostructures. The second set of nanostructures is substantially perpendicular to the first set of conductive nanostructures.

In some embodiments, a method for making an electronic device includes providing a first electrode, an electro-responsive layer, and a second electrode. The electro-responsive layer is positioned between the first electrode and the second electrode to form an electronic device. The electro-responsive layer faces a first conductive nanostructured grid. The method includes depositing the conductive nanostructured grid on a surface of the first electrode. The conductive nanostructured grid is formed by applying a coating composition onto the first surface of the first electrode in a coating direction to form a chromonic layer. The coating composition comprises a chromonic material, surface modified inorganic nanoparticles, and water to form a chromonic layer. The chromonic layer is at least partially dried to form a dried chromonic layer having chromonic material and surface modified inorganic nanoparticles. The dried chromonic layer is exposed to a hydrophilic organic solvent to form a channel pattern within the dried chromonic layer. The channel pattern comprises a first set of channels in the coating direction and a second set of channels that are substantially perpendicular to the first set of channels. A metal containing material is then disposed on a surface of the dried chromonic layer, and within both the first set of channels and the second set of channels of the dried chromonic layer. The metal containing material within the first set of channels and the second set of channels contacts the first electrode. The dried chromonic layer and the metal containing material disposed on the dried chromonic layer are removed. The metal containing material disposed within the first set of channels and the second set of channels adheres to the first electrode to form a first conductive nanostructured grid.

Electrodes are generally any conductive material or conductive layer. Conductive materials used as electrodes include metals, alloys, metallic compounds, metal oxides, conductive ceramics, conductive dispersions, and conductive polymers. Some suitable conductive materials may contain, for example, gold, platinum, palladium, nickel, aluminum, calcium, barium, magnesium, titanium, titanium nitride, indium tin oxide (ITO), antimony tin oxide (ATO), fluorine doped tin oxide (FTO), zinc oxide, fluorine doped zinc oxide, indium zinc oxide (IZO), graphite and polyaniline. Examples of suitable transparent conductive oxides are described in Gordon, T. G., MRS Bulletin, 52-57 (August 2000); and Granqvist, C. G., Thin Solid Films, 411, 1-5 (2002). Multiple layers of conductive materials may be combined for forming an electrode. An electrode may include a single layer or multiple layers of conductive materials. For example, an electrode may include a layer of aluminum and a layer of gold, a layer of aluminum and a layer of lithium fluoride, or a metal layer and a conductive organic layer. In some embodiments, the electrode is a layer of a multilayer structure. In other embodiments, the first electrode may comprise the same material as the second electrode.

In some embodiments, the conductive layer may be supported by a substrate of a multilayer structure. The substrate may be conductive or nonconductive. The substrate generally can generally accept the application of a conductive layer (i.e., electrode). In some embodiments, a first conductive nanostructured grid may be deposited on a surface of a substrate. The substrate may be transparent or semi-transparent. The substrate may also be semi-flexible, flexible or rigid. Examples of transparent flexible substrates include, for example, polyesters (e.g., polyethylene terephthalate, and polyethylene naphthalate), polyolefins (e.g., linear, branched, and cyclic polyolefins), polyvinyls (e.g., polyvinyl chloride, polyvinylidene chloride, polyvinyl acetal, polystyrene, polyacrylate, and the like), cellulose esters (e.g., cellulose triacetate, cellulose acetate), polysulphones (e.g., polyethersulphone) and combinations of thereof. Some examples of transparent rigid substrates include, for example, polycarbonate, acrylic, glass, and combinations thereof. Some examples of conductive substrates include metallic films (e.g., aluminum or nickel foil, and copper), surface reactive films, and combinations thereof.

In some embodiment, substrates may be treated with a primer layer to facilitate coating of a conductive layer. The primer layer can improve wetting of the substrate for receiving a conductive layer, or to improve the adhesion of the conductive layer to the substrate. Primer layers may be applied or formed on the substrate using techniques such as sputtering (e.g., cathode or planar magnetron sputtering), evaporation (e.g., resistive or electron beam evaporation), chemical vapor deposition, plating, plasma treatment (e.g., corona treatment or oxygen glow discharge), or combinations thereof. Some examples of primer layers include inorganic materials; for example, glass or inorganic oxides, oxides of silicon (e.g., silicon oxide or silicon dioxide), aluminum oxide, silicon aluminum oxide, or combinations thereof. Suitable inorganic oxide coatings as primer layers are described in U.S. Pat. No. 5,753,373 (Scholz et al.). Some other inorganic materials as primer layers are described in U.S. Patent Application Publication No 2006/0063015 (McCormick et al.).

Conductive layers may be applied to a substrate for forming a multilayer structure. The conductive layer may be applied by sputter deposition coating, electron beam coating, vacuum deposition coating, laser thermal patterning, inkjet printing, screen printing, thermal head printing, and photolithographic pattering, or combinations thereof. In some embodiments, conductive layers applied onto substrates are generally referred to as transparent conducting oxides (TCOs).

TCOs are known for their electrical conductivity and their optical transparency. During application of TCOs onto substrates, the charge carrier concentration (e.g., free electrons) increases, and the optical transparency decreases which may limit the thickness of the conductive layer. Some conductive layers deposited on substrates for forming multilayer structures include indium tin oxide (ITO), antimony tin oxide (ATO), fluorine doped tin oxide, aluminum doped tin oxide, zinc oxide, fluorine doped zinc oxide, indium zinc oxide (IZO), or combinations thereof.

An additional conductive layer can be applied to a surface of an electrode to improve surface conductivity, improve robustness, and reduce defects in the electrode. The surface of the first electrode may optionally contain a primer layer, a conductive layer or a combination thereof. In one embodiment, the first conductive nanostructured grid is deposited on the surface of the first electrode. A coating composition is applied to the surface of the electrode to form a chromonic layer. The coating composition comprises a chromonic material, surface modified inorganic nanoparticles, and water. At least a portion of the water from the chromonic layer is removed to form a dried chromonic layer. The dried chromonic layer is then exposed to a hydrophilic organic solvent to form a channel pattern. The channel pattern comprises a first set of channels and a second set of channels. The second set of channels is substantially perpendicular to the first set of channels. A metal containing material is disposed on a surface of the dried chromonic layer and within the first set of channels and the second set of channels. The metal containing material disposed with the first set of channels and the second set of channels contacts the first electrode. The dried chromonic layer and the metal containing material disposed on the surface of the dried chromonic layer are removed. After removing the dried chromonic layer and the metal containing material, the metal containing material disposed within the first set of channels and the second set of channels adheres to the surface of the first electrode forming a first conductive nanostructured grid.

In one embodiment, a first electrode comprises a conductive layer that is an outermost layer of a multilayer structure. Conductive layers used in the multilayer structure may include indium tin oxide (ITO), fluorine doped tin oxide, aluminum doped tin oxide, zinc oxide, or combinations thereof. The conductive layer may be deposited on a substrate. A first conductive nanostructured grid may be deposited on the conductive layer.

In another embodiment, a conductive layer may be deposited on a first conductive nanostructured grid that is previously on a substrate for forming a first electrode structure.

The coating composition applied to the surface of the first electrode comprises chromonic material, surface modified inorganic nanoparticles, and water. Chromonic materials or molecules are capable of forming a chromonic phase or assembly when dissolved in an aqueous solution, which may or may not be alkaline. The chromonic molecules have a hydrophobic core surrounded by hydrophilic groups. Chromonic phases or assemblies often contain stacks of flat, multi-ring aromatic molecules. Molecular stacking takes on a number of morphologies, but is typically characterized by a tendency to form columns created by a stack of molecular layers. Ordered stacks of molecules are formed that grow with increasing concentration, but they are distinct from micellar phases. Unlike micellar phases, chromonic phases generally do not have surfactant-like properties and do not exhibit a critical micellar concentration. In some embodiments, the chromonic phases will exhibit isodesmic behavior. That is, addition of chromonic molecules to an ordered stack leads to a monotonic decrease in free energy. The chromonic M phase (i.e., hexagonal phase) is generally characterized by ordered stacks of molecules arranged in a hexagonal lattice. The chromonic N phase (i.e., nematic phase) is characterized by a nematic array of columns. There is long range ordering along the columns characteristic of a nematic phase, but little or no ordering amongst the columns. The N phase is less ordered than the M phase. The chromonic N phase generally exhibits a schlieren texture, which is characterized by regions of varying index of refraction in a transparent medium.

Some compounds that form chromonic phases include, for example, dyes (e.g., azo dyes and cyanine dyes) and perylenes (e.g., Kawasaki et al., Langmuir, 16, 5409 (2000), or Lydon, J., Colloid and Interface Science, 8, 480 (2004)). Representative examples of useful chromonic materials include di-palladium and mono-palladium organyls, sulfamoyl-substituted copper phthalocyanines, and hexaaryltryphenylene.

Another chromonic molecule can be a non-polymeric molecule comprising more than one carboxyl functional group that can associate with mono-valent or multi-valent cations. The carboxyl groups may be directly attached to an aromatic (e.g., carboxyphenyl) or heteroaromatic functional group. When the chromonic molecule has more than one aromatic or heteroaromatic functional group, the carboxyl groups may be arranged such that each aromatic or heteroaromatic group generally has no more than one carboxyl group directly attached.

In other embodiments, the chromonic molecule may contain at least one formal positive charge. For example, the chromonic molecule may be zwitterionic, with at least one formal positive and at least one formal negative charge. In some chromonic molecules, the negative charge can be carried by an acidic group having a dissociated hydrogen atom such as a carboxyl group in its basic form (i.e., —COO⁻). The negative charge can be carried by multiple carboxyl functional groups present, such that a proper representation of the chromonic molecule has two or more resonance structures or structural isomers.

In further embodiments, chromonic molecules may include triazine derivatives with the structure shown in Formula I.

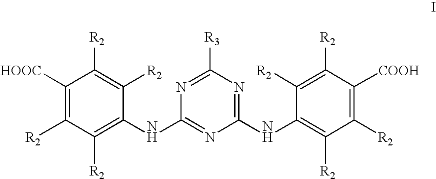

The compounds of Formula I have an orientation such that the carboxyl (—COOH) group may be para with respect to the amino linkage to the triazine center of the compound. Although the chromonic molecule is neutral as depicted in Formula I, it may exist in alternative forms, such as a zwitterion or as a proton tautomer. For example, a hydrogen atom can be dissociated from one of the carboxyl groups, and can be associated with one of the nitrogen atoms in the triazine ring or with one of the amino linkages. Further, the chromonic molecule may also be a salt. The carboxyl group may also be meta with respect to the amino linkage, as shown in Formula II, or it may be a combination of para and meta orientations.

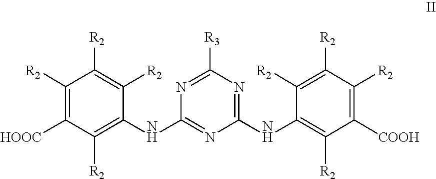

Each R₂ of Formulas I and II may be independently selected from any electron donating group, electron withdrawing group, electron neutral group, or combinations thereof. In some embodiments, R₂ may be hydrogen, a substituted or unsubstituted alkyl group, a substituted or unsubstituted alkoxy group (i.e., an alkoxy group having a formula —OR where R is an alkyl), a substituted or unsubstituted carboxyalkyl group (i.e., a carboxyalkyl group having a formula —(CO)OR where (CO) denotes a carbonyl and R is an alkyl), or combinations thereof. Suitable substituents include hydroxyl, alkoxy, carboxyalkyl, sulfonate, halide functional groups, or combinations thereof. In one embodiment, R₂ may be hydrogen.

Group R₃ of Formulas I and II may be selected from a substituted heteroaromatic ring, unsubstituted heteroaromatic ring, a substituted heterocyclic ring, or an unsubstituted heterocyclic ring that is linked to the triazine group through a nitrogen atom within the ring of R₃. As used herein, the term “heterocyclic” refers to a hydrophilic organic group having a ring structure that includes a heteroatom such as oxygen, nitrogen, sulfur, wherein the ring structure can be saturated or partially saturated. As used herein, the term “heteroaromatic” refers to an organic group having a ring structure that includes a heteroatom such as oxygen, nitrogen, or sulfur, wherein the ring structure is unsaturated.

R₃ can be, but is not limited to, a heteroaromatic ring derived from pyridine, pyridazine, pyrimidine, pyrazine, imidazole, oxazole, isoxazole, thiazole, oxadiazole, thiadiazole, pyrazole, triazole, triazine, quinoline, or isoquinoline. In many embodiments, R₃ includes a heteroaromatic ring derived from pyridine or imidazole. A substituent for the heteroaromatic ring R₃ may be selected from, but is not limited to, any of the following substituted and unsubstituted groups: alkyl, carboxyl, amino, alkoxy, thio, cyano, carbonylaminoalkyl (i.e., a group having a formula —(CO)NHR where (CO) denotes a carbonyl and R is an alkyl), sulfonate, hydroxy, halide, perfluoroalkyl, aryl, alkoxy, or carboxyalkyl. In some embodiments, a substituent for R₃ may be selected from alkyl, sulfonate, carboxyl, halide, perfluoroalkyl, aryl, alkoxy, or alkyl substituted with hydroxyl, sulfonate, carboxyl, halide, perfluoroalkyl, aryl, or alkoxy.

In some embodiments, R₃ may be derived from a substituted pyridine with the substituent being preferably located at the 4-position. In other embodiments, R₃ may be derived from a substituted imidazole with the substituent being preferably located at the 3-position. Suitable examples of R₃ may include, but are not limited to: 4-(dimethylamino)pyridinium-1-yl, 3-methylimidazolium-1-yl, 4-(pyrrolidin-1-yl)pyridinium-1-yl, 4-isopropylpyridinium-1-yl, 4-[(2-hydroxyethyl)methylamino]pyridinium-1-yl, 4-(3-hydroxypropyl)pyridinium-1-yl, 4-methylpyridinium-1-yl, quinolinium-1-yl, 4-tent-butylpyridinium-1-yl, and 4-(2-sulfoethyl)pyridinium-1-yl, as illustrated in Formulas IV to XIII below. Examples of heterocyclic rings that R₃ may be selected from include, for example, morpholine, pyrrolidine, piperidine, or piperazine.

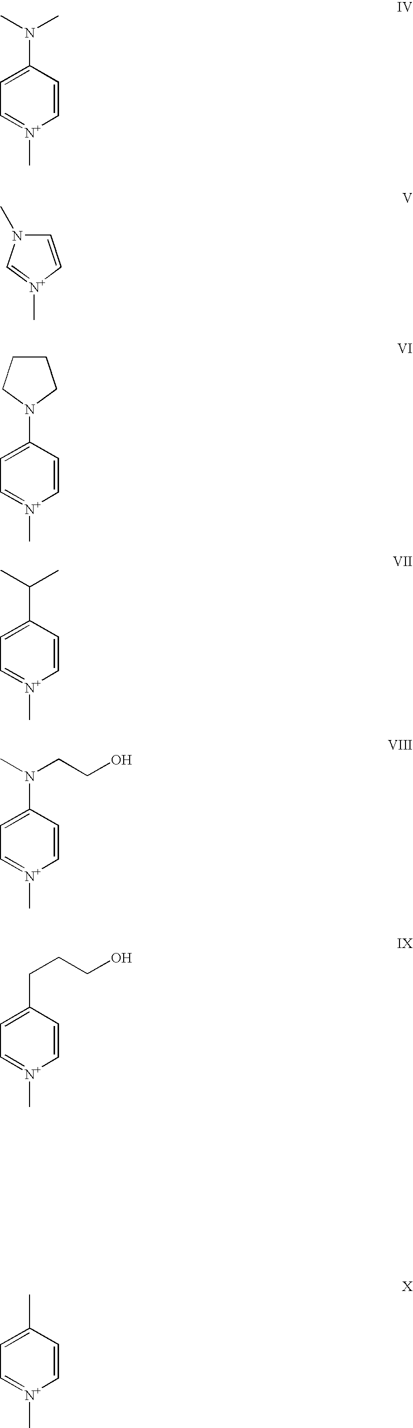

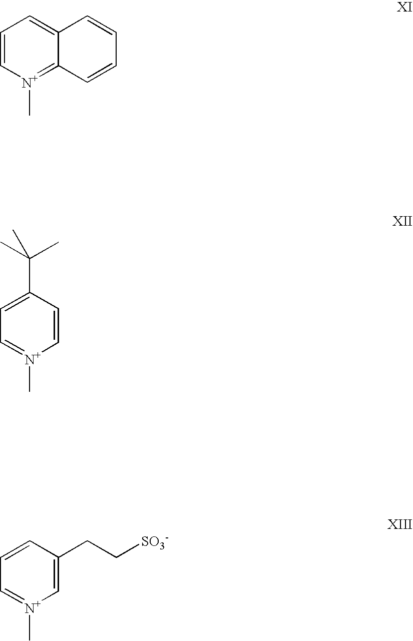

Some exemplary R₃ groups are of Formula XIV,

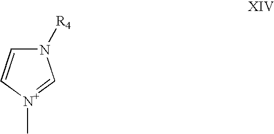

where R₄ of Formula XIV may be hydrogen, a substituted alkyl group, or an unsubstituted alkyl group. In some embodiments, R₄ may be hydrogen, an unsubstituted alkyl group, or an alkyl group substituted with a hydroxy, an alkoxy, a carboxyalkyl, a sulfonate, or a halide functional group. Some specific examples of R₄ may be methyl, propylsulfonic acid, or oleyl (i.e., fatty alcohol). Formula V may be a subset of Formula XIV where R₄ is methyl.

As depicted above, the chromonic molecules of Formula I or II are neutral; however, chromonic molecules described herein may exist in an ionic form having one formal positive charge. One example of a chromonic molecule is 4-dimethylamino-1-[4,6-di(4-carboxyphenylamino)-1,3,5-triazin-2-yl]pyridinium chloride (Formula III) as described in U.S. Pat. No. 6,488,866 (Sahouani et al.). In the chromonic compound shown in Formula III, R₃ is a dimethylamino substituted pyridine ring linked to the triazine group through the nitrogen atom of the pyridine ring. As shown, the pyridine nitrogen carries a positive charge, and a chloride ion carries a negative charge.

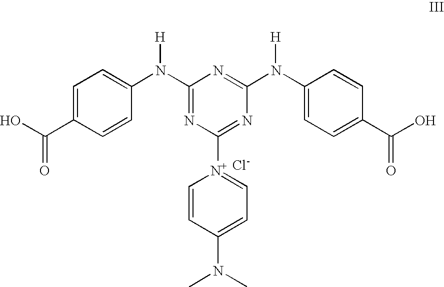

The chromonic molecule shown in Formula III may also exist in other tautomeric forms, such as where one or both carboxyl functional groups carry a negative charge and where positive charges are carried by one of the nitrogen atoms in the triazine group and the nitrogen on the pyridine group. In another embodiment, the chromonic molecule may be zwitterionic, such as 4-({4-[(4-carboxylphenyl)amine]-6-[4-(dimethylamino)pyridinium-1-yl]-1,3,5-triazin-2-yl}amino)benzoate as described in U.S. Pat. No. 5,948,487 (Sahouani et al.).

U.S. Pat. No. 5,948,487 (Sahouani et al.) describes triazine derivatives of Formula I prepared as aqueous solutions or as salts, which can later be re-dissolved to form an aqueous solution. A typical synthetic route for the triazine molecules shown in Formula I above involves a two-step process. Cyanuric chloride may be treated with 4-aminobenzoic acid to give 4-{[4-(4-carboxyanilino)-6-chloro-1,3,5-triazin-2-yl]amino}benzoic acid. This intermediate may be treated with a substituted or unsubstituted nitrogen-containing heterocycle. The nitrogen atom of the heterocycle may displace the chlorine atom on the triazine to form a corresponding chloride salt. The zwitterionic derivative of Formula III may be prepared by dissolving the chloride salt in ammonium hydroxide, passing it through an anion exchange column to replace the chloride with hydroxide, and removing the solvent. Alternative structures, as in Formula II, may be obtained by using 3-aminobenzoic acid instead of 4-aminobenzoic acid for forming triazine-containing chromonic molecules.

In addition to the chromonic molecules, surface modified inorganic nanoparticles are included in the coating compositions applied to the surface of the first electrode. In general, surface modified inorganic nanoparticles are physically or chemically modified to provide properties that are different from unmodified inorganic nanoparticles. Many suitable classes of surface-modifying agents for modifying an inorganic nanoparticle surface are known to those skilled in the art, and include silanes, organic acids, organic bases, alcohols, or combinations thereof. The surface groups may be present on the surface of the inorganic nanoparticles in an amount sufficient to form inorganic nanoparticles that may be suspended in an aqueous solution with minimal aggregation or agglomeration.

Suitable inorganic nanoparticles may include, for example, calcium phosphate, calcium hydroxyapatite, and metal oxide nanoparticles such as silica, zirconia, titania, ceria, alumina, iron oxide, vanadia, zinc oxide, antimony oxide, tin oxide, nickel oxide, and combinations thereof. The inorganic nanoparticles can be composite materials such as, for example, alumina/silica, iron oxide/titania, titania/zinc oxide, zirconia/silica, and combinations thereof. In one embodiment, the inorganic nanoparticles are one of at least silica, zirconia, or titania.

Surface modified inorganic nanoparticles or precursors to them may be in the form of a colloidal dispersion. Some of these dispersions are commercially available as unmodified silica starting materials, for example, such as nano-sized colloidal silicas available under the product designations “NALCO 1040,” “NALCO 1050,” “NALCO 1060,” “NALCO 2326,” “NALCO 2327,” and “NALCO 2329” from Nalco Chemical Company; Naperville, Ill. One example of a metal oxide colloidal dispersion includes colloidal zirconium oxide, as described, for example, in U.S. Pat. No. 5,037,579 (Matchett). Colloidal titanium oxide, as described, in U.S. Pat. Nos. 6,329,058 and 6,432,526 (Arney et al.) represents another example of a metal oxide colloidal dispersion.

Selected inorganic nanoparticles may be used alone or in combination with one or more other nanoparticles to provide mixtures and combinations of nanoparticles. The selected inorganic nanoparticles in whatever form employed, will generally have an average particle diameter of 500 nanometers or less. In some embodiments, the inorganic nanoparticles may be utilized having an average particle diameter of at least 2, at least 5, at least 10, at least 25, at least 50, or at least 100 nanometers. In further embodiments, the inorganic nanoparticles may have an average particle diameter up to 500, up to 400, up to 250, or up to 150 nanometers. The inorganic nanoparticles may have an average particle diameter in a range of 2 to 500 nanometers, in the range of 5 to 400 nanometers, in the range of 5 to 250 nanometers, or in the range of 10 to 150 nanometers. If the chosen nanoparticles or combinations of nanoparticles are themselves aggregated, the maximum preferred cross-sectional dimension of the aggregated nanoparticles will be within any of the stated ranges.

In some cases, it may be desirable for the inorganic nanoparticles utilized to be substantially spherical in shape. In other applications, however, more elongated shapes may be desired. Aspect ratios of at least 1, at least 2, at least 3, or at least 5 may be utilized. In some embodiments, aspect ratios up to 10, up to 9, up to 8, or up to 7 may be utilized. In other embodiments, the aspect ratio of the inorganic nanoparticles may be in a range of 1 to 10, 2 to 9, 3 to 8, or 3 to 7. As used herein, the term “aspect ratio” refers to the longest length of the particle divided by the distance perpendicular to the longest length.

Inorganic nanoparticles may be selected such that the inorganic nanoparticles are essentially free from a degree of particle association, agglomeration, or aggregation that may interfere with the desired properties when mixed with chromonic materials and water of a coating composition. As used herein, particle “association” is defined as a reversible chemical combination due to any of the weaker classes of chemical bonding forces. Examples of particle association include hydrogen bonding, electrostatic attraction, London forces, van der Waals forces, and hydrophobic interactions. As used herein, the term “agglomeration” is defined as a combination of molecules or colloidal particles into clusters. Agglomeration may occur due to the neutralization of the electric charges, and is typically reversible. As used herein, the term “aggregation” is defined as the tendency of large molecules or colloidal particles to combine in clusters or clumps and precipitate or separate from the dissolved state. Aggregated inorganic nanoparticles are firmly associated with one another, and require high shear to be broken. Agglomerated and associated inorganic nanoparticles can generally be easily separated.

The surface of the selected inorganic nanoparticles can be chemically or physically modified in some manner. Modifications to the inorganic nanoparticle surface may include, for example, covalent chemical bonding, hydrogen bonding, electrostatic attraction, London forces, and hydrophilic or hydrophobic interactions so long as the interaction is maintained at least during a time period sufficient for the inorganic nanoparticles to achieve their intended utility. The surface of a nanoparticle may be modified with one or more surface modifying groups. The surface modifying groups may be derived from a myriad of surface modifying agents. Schematically, surface modifying agents may be represented by Formula XV.

A−B XV

Group A in Formula XV is a group that is capable of attaching to the surface of an inorganic nanoparticle. In situations where the nanoparticle is processed in solvent, group B is a compatibilizing group with whatever solvent is used to process the inorganic nanoparticles. In some situations where the inorganic nanoparticles are not processed in solvent, group B is capable of preventing irreversible agglomeration of the inorganic nanoparticles. It is possible for group A and group B to be the same, where the attaching group may also be capable of providing the desired surface compatibility. The compatibilizing group may be reactive, but is generally non-reactive, with the chromonic material.

It is understood that the surface modifying agents may be comprised of more than one group or created in more than one step. For example, a surface modifying agent composition may be comprised of an A′ group which is reacted with the surface of a nanoparticle, followed by an A″ group which can then be reacted with a B group. The sequence of addition is not important, i.e., the A′A″B component reactions can be wholly or partly performed prior to attachment to the nanoparticle. Further description of nanoparticles in coatings can be found in Linsenbuhler, M. et al., Powder Technology, 158, 3 (2003).

A variety of methods are available for modifying the surfaces of inorganic nanoparticles. A surface modifying agent may, for example, be added to nanoparticles (e.g., in the form of a powder or a colloidal dispersion) and the surface modifying agent may be allowed to react with the nanoparticles. Multiple synthetic sequences to bring the nanoparticle together with the surface modifying group are possible. Some examples of surface modification processes of nanoparticles are described, for example, in U.S. Pat. Nos. 2,801,185 (Iler); 4,522,958 (Das et al.); and 6,586,483 (Kolb et al.).

In some embodiments, surface-modifying agents may include silane compounds. Some examples of silanes may include organosilanes such as alkylchlorosilanes; alkoxysilanes (e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltrimethoxysilane, phenyltriethoxysilane, polytriethoxysilane, trialkoxyarylsilanes, isooctyltrimethoxysilane); N-(3-triethoxysilylpropyl)methoxyethoxyethoxy ethyl carbamate; N-(3-triethoxysilylpropyl)methoxyethoxyethoxyethyl carbamate; 3-(triethoxysilyl)propylsuccinic anhydride, alkylsilanes (e.g., substituted and unsubstituted alkyl silanes (e.g., methoxy and hydroxy substituted alkyl silanes)), and combinations thereof.

In other examples, a silane compound has an ionizable group selected from hydroxyl, alkoxy, carboxyl, halogen, —OPO₃H₂, —PO₃H₂, thiol, amino, or a salt thereof. The ionizable group can be either in an acid or in salt form (e.g., counterions can include alkali metals, alkyl ammonium, or combinations thereof). In some examples, the silane has at least two ionizable groups. In other examples, the silane compound with an ionizable group can be of Formula XVI.

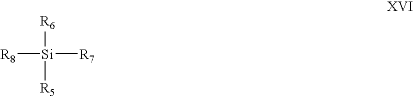

In Formula XVI, R₅ may be hydroxyl, alkoxy, halide, or combinations thereof. Similarly, R₆ and R₇ may independently be hydroxyl, alkoxy, halide, or combinations thereof. In some embodiments, R₅, R₆, and R₇ may be the same group. In other embodiments, R₅, R₆, and R₇ independently may be different groups. In another embodiment, two of R₅, R₆, or R₇ may be the same group, and one of R₅, R₆, or R₇ may be a different group. In one embodiment, when R₅, R₆, and R₇ are hydroxyl, the ionizable group may be a salt. Substituent Y can be a divalent group, such as an alkylene, an arylene, an oxyalkylene, or combinations thereof. Y can be attached to both silicon, and to R₈. R₈ may be an ionizable group, where R₈ may be —COOH, —OH, —OR (where R is an alkyl group), —OPO₃H₂, —PO₃H₂, —SH, —NH, anhydride, or a salt thereof. Modification of the inorganic nanoparticles with an organosilane having an ionizable group may stabilize the inorganic nanoparticles in water.

In one embodiment, the organosilane of Formula XVI comprises R₅, R₆, and R₇, where each are alkoxy having 1 to 10 carbon atoms. In another embodiment, R₅, R₆, and R₇ of Formula XVI is a halide, where the halide is chloride. In a further embodiment, R₅, R₆, and R₇ of Formula XVI are each hydroxyl.

In some embodiments, R₅, R₆, and R₇ of Formula XVI are hydroxyl, where at least one of the hydroxyl groups is an ionizable group. In another embodiment, R₅, R₆, and R₇ of Formula XVI are hydroxyl, and R₈ is selected from hydroxyl, or carboxyl.

In one embodiment, an organosilane of Formula XVI, where each of R₅, R₆, and R₇ are hydroxyl, R₈ is carboxyl, and Y is ethylene. One of R₅, R₆, and R₇ is an ionizable group. In one embodiment, the organosilane is carboxyethyl silane triol sodium salt.

Rather than using silane compounds, inorganic nanoparticle surfaces may be modified with organic acid surface-modifying agents which include oxyacids of carbon (e.g., carboxylic acid), oxyacids of sulfur and oxyacids of phosphorus, acid derivatized poly(ethylene) glycols (PEGs) or combinations of any of these. Suitable phosphorus containing acids include phosphonic acids (e.g., octylphosphonic acid, laurylphosphonic acid, decylphosphonic acid, dodecylphosphonic acid, and octadecylphosphonic acid), monopolyethylene glycol phosphonate and phosphates (e.g., lauryl or stearyl phosphate). Suitable sulfur containing acids include sulfates and sulfonic acids including dodecyl sulfate and lauryl sulfonate. Any such acids may be used in either acid or salt forms.

In some embodiments, surface modifying agents incorporate a carboxylic acid functionality such as CH₃O(CH₂CH₂O)₂CH₂COOH, 2-(2-methoxyethoxy)acetic acid having the chemical structure CH₃OCH₂CH₂OCH₂COOH, mono(polyethylene glycol) succinate in either acid or salt form, octanoic acid, dodecanoic acid, steric acid, acrylic or oleic acid. The salt form of octanoic acid, dodecanoic acid, steric acid, acrylic acid or oleic acid may be used as surface modifying agents. In a further embodiment, surface modified iron oxide nanoparticles include those modified with endogenous fatty acids (e.g., stearic acid) or fatty acid derivatives using endogenous compounds (e.g., stearoyl lactylate or sarcosine or taurine derivatives). Further, surface modified zirconia nanoparticles include a combination of oleic acid and acrylic acid adsorbed onto the surface of the particle.

Organic base surface modifying agents for inorganic nanoparticles may include alkylamines (e.g., octylamine, decylamine, dodecylamine, octadecylamine, and monopolyethylene glycol amines).

Surface-modifying alcohols and thiols may also be employed including aliphatic alcohols (e.g., octadecyl, dodecyl, lauryl and furfuryl alcohol), alicyclic alcohols (e.g., cyclohexanol), and aromatic alcohols (e.g., phenol and benzyl alcohol), and combinations thereof.

An amount of a surface modifying agent can be selected to react with the surface of the inorganic nanoparticles. In one embodiment, the inorganic nanoparticles are silica nanoparticles. Reaction of the surface modifying agent with the silica nanoparticles may be sufficient to provide a stable suspension of surface modified silica nanoparticles. The surface modified silica nanoparticles in a coating composition can be effective for providing a channel pattern. The amount (e.g., millimoles) of surface modifying agent per gram of dry silica nanoparticles can be at least 0.001 millimoles (mmoles), at least 0.01 mmoles, at least 0.03 mmoles, at least 0.05 mmoles, or at least 0.1 mmoles. The amount of surface modifying agent per gram of dry silica nanoparticles may be in an amount up to 2.5 mmoles, up to 1.5 mmoles, up to 1 mmoles, or up to 0.5 mmoles. In some embodiments, the amount of surface modifying agent per gram of dry silica nanoparticles may be in a range of 0.001 to 2.5 mmoles, 0.01 to 1.5 mmoles, 0.03 to 1 mmoles, or 0.03 to 0.5 mmoles.

The coating composition contains a chromonic material, surface modified inorganic nanoparticles, and water. A pre-coating composition may be formed from the above components including an aqueous suspension of surface modified inorganic nanoparticles, water, a pH-adjusting compound, and an optional surfactant prior to the addition of the chromonic material. The pre-coating composition may be combined and mechanically agitated in a container. The chromonic material may be subsequently added and dissolved in the pre-coating composition to form the coating composition.

A pre-coating composition may comprise one or more pH-adjusting compounds and an optional surfactant. The addition of a pH-adjusting compound often allows a chromonic material to become more soluble in an aqueous dispersion. Suitable pH-adjusting compounds include any known base such as, for example, sodium hydroxide, potassium hydroxide, lithium hydroxide, ammonium hydroxide (NH₄OH), or various amines. The pH of the pre-coating composition may be at least 5, at least 6, at least 7, at least 8, or at least 9. In some embodiments, the pH may be up to 12, up to 11, or up to 10. In some embodiments, the pH may be in a range of 5 to 12, 6 to 11, or 7 to 11. The optional surfactant may be added to the pre-coating composition to promote wetting of the coating composition on the surface of a substrate. Suitable surfactants include ionic surfactants, non-ionic surfactants, or combinations thereof. Optional additives such as viscosity modifiers (e.g., polyethylene glycol) or binders (e.g., low molecular weight hydrolyzed starches) can also be added. Some of the optional additives or optional surfactants may be added to the pre-coating composition in an amount of at 0.4, at least 0.5, at least 1, or at least 3 weight percent of the pre-coating composition. In some embodiments, the optional additives or optional surfactants may be added to the pre-coating composition in an amount up to 10, up to 7, or up to 5 weight percent of the pre-coating composition. In other embodiments, the optional additives or optional surfactants may be added to the pre-coating composition in a range of 0.4 to 10 weight percent, 0.5 to 10 weight percent, 1 to 7 weight percent, 3 to 7 weight percent, or 3 to 5 weight percent of the pre-coating composition. One or more organic solvents, in some embodiments, may be added to the pre-coating composition. The organic solvents can be added to the pre-coating composition to achieve an organic solvent concentration of at least 0.1, at least 0.5, at least 1, at least 3, or at least 5 weight percent of the pre-coating composition. The organic solvents can be added to the pre-coating composition to achieve an organic solvent concentration up to 10, up to 9, up to 8, or up to 7 weight percent of the pre-coating composition. Organic solvents can be added to the pre-coating composition to achieve an organic solvent concentration in a range of 0.1 to 10 weight percent, 0.5 to 10 weight percent, 1 to 8 weight percent, or 3 to 7 weight percent of the pre-coating composition.

An aqueous dispersion of surface modified inorganic nanoparticles can be added to the pre-coating composition prior to the addition of a chromonic material. The surface modified inorganic nanoparticles of the pre-coating composition may have a concentration of at least 10, at least 15, or at least 17 weight percent. The surface modified inorganic nanoparticles of the pre-coating composition may have a concentration up to 30, up to 25, or up to 20 weight percent. In some embodiments, the surface modified inorganic nanoparticles may have a concentration in a range of 10 to 30 weight percent, 10 to 25 weight percent, 15 to 25 weight percent, or 17 to 20 weight percent of the pre-coating composition.

Chromonic materials can be added as a component to the pre-coating composition at room temperature or at a temperature less than approximately 40° C. to dissolve the chromonic material for forming a coating composition. The relative concentrations of each of the components of the coating composition may vary with the desired orientation of the resulting conductive nanostructured grids and their intended application. In general, however, the chromonic material may be added to the pre-coating composition to achieve a concentration of at least 3, at least 4, at least 5, or at least 7 weight percent of the coating composition. The chromonic material may be added to the pre-coating composition to achieve a concentration up to 20, up to 15, or up to 10 weight percent of the coating composition. In some embodiments, the chromonic material may be added to the pre-coating composition to a achieve a concentration in a range of 3 to 20 weight percent, 4 to 20 weight percent, 5 to 15 weight percent, 7 to 15 weight percent, or 4 to 10 weight percent of the coating composition.

A coating composition may be mixed with a non-chromonic phase including an organic water-soluble molecule that forms a homogenous phase with the chromonic material. In some embodiments, the organic water-soluble molecule is a saccharide such as a monosaccharide, disaccharide, trisaccharide, or polysaccharide. For example, the organic water-soluble molecule may include polysaccharides such as starch, corn starch, amylopectin, maltodextrins, or corn syrup solids. Alternatively, the organic water-soluble molecule can include a monosaccharide such as glucose or fructose, and disaccharides such as sucrose, maltose, or lactose. The organic water-soluble molecule can be present in any useful amount. The organic water-soluble molecule may be present in the coating composition to achieve a concentration of at least 1, at least 5, at least 10, at least 15, or at least 25 weight percent of the coating composition. In some embodiments, the organic water-soluble molecule may be present in the coating composition to achieve a concentration up to 50, up to 40, up to 35, or up to 30 weight percent of the coating composition. The organic water-soluble molecule may be present in the coating composition to achieve a concentration in a range of 1 to 50 weight percent, 1 to 40 weight percent, 5 to 35 weight percent, or 10 to 30 weight percent of the coating composition.

The coating composition is applied in a coating direction to a surface of a first electrode. In one embodiment, the first electrode is a conductive layer deposited on a substrate of a multilayer structure.

The coating composition can be applied by any useful means that provides for the ordered arrangement of chromonic materials and surface modified inorganic nanoparticles within the chromonic layer. Suitable coating techniques include, for example, roll coating, die coating, dip coating, spray coating, knife coating, or curtain coating. In some embodiments, shear orientation can be applied to the chromonic layer either during or after application to the first electrode. The application of shear force to the chromonic layer can help promote alignment of the chromonic materials such that, upon removal of at least a portion of the water, the dried chromonic layer has an oriented structure or matrix. The surface modified inorganic nanoparticles of the coating composition may also provide defects in the alignment of the chromonic materials. Defects may result in the formation of a channel pattern comprising a first set of channels and a second set of channels. The second set of channels extend in a substantially perpendicular direction relative to the coating direction. In one embodiment, the alignment of the chromonic materials with the surface modified inorganic nanoparticles may result in the formation of a channel pattern which may be in both 1) a direction of the applied force during the coating process forming a first set of channels and 2) in a direction substantially perpendicular to the applied force during the coating process forming a second set of channels.

The coating composition can be applied to the surface of a first electrode at any useful wet coating thickness. The coating composition may be applied to the surface of the first electrode at a uniform wet coating thickness of at least 1, at least 3, at least 5, or at least 10 micrometers. In some embodiments, the coating composition may be applied to the surface of the first electrode at a uniform wet coating thickness of up to 25, up to 20, up to 15, or up to 12 micrometers. Generally, the coating composition may be applied to the surface of the first electrode at a uniform wet coating thickness in a range of 1 to 25 micrometers, 3 to 20 micrometers, 5 to 20 micrometers, 5 to 15 micrometers, or 5 to 10 micrometers.

After applying the coating composition to form a chromonic layer on the surface of the first electrode, at least a portion of the water can be removed from the chromonic layer to form a dried chromonic layer. That is, as used herein, the term “dried chromonic layer” refers to a chromonic layer that has been at least partially dried. Drying of the coated chromonic layer can be achieved using any means suitable for drying aqueous coatings. Useful drying methods will not damage the coating or significantly disrupt the orientation of the coated chromonic layer imparted during coating or application. In some embodiments water is removed from the chromonic layer via evaporation with or without the application of heat to the chromonic layer to form a dried chromonic layer. At least 5, at least 25, at least 50, or at least 75 weight percent of the water (based on the total weight of the coating composition) may be removed from the chromonic layer to form the dried chromonic layer. In some embodiments, up to 95, up to 90, up to 85, or up to 80 weight percent of the water may be removed from the chromonic layer to form the dried chromonic layer. The weight percent of water that may be removed from the chromonic layer to form the dried chromonic layer may be in a range of 5 to 95 weight percent, 25 to 90 weight percent, 25 to 85 weight percent, or 50 to 80 weight percent.

After removal of water from the chromonic layer, a dried chromonic layer may be formed. The average thickness of the dried chromonic layer, in some embodiments, may be at least 50 nanometers, at least 75 nanometers, or at least 100 nanometers. The average thickness of the dried chromonic layer may be up to 2 micrometers, up to 1 micrometer, or up to 0.5 micrometers. The dried chromonic layer may have an average thickness in a range of 50 nanometers to 2 micrometers, 200 nanometers to 2 micrometers, 200 nanometers to 1.5 micrometers, or 500 nanometers to 1.5 micrometers.

A dried chromonic layer can be exposed to an organic solvent to form a channel pattern. In some embodiments, the organic solvent may not dissolve a chromonic material in the dried chromonic layer. The organic solvent may be a hydrophilic organic solvent. The organic solvent that may be applied to the dried chromonic layer may include alcohols (e.g., ethanol, 1-propanol, 2-propanol, 1-butanol, 2-butanol, or tertiary butanol), ketones (e.g., acetone, methyl ethyl ketone, cyclopentanone, dimethyl carbonate, diethyl carbonate, or cyclohexanone), or combinations thereof. Other useful organic solvents may include nitriles (e.g., acetonitrile), ethers (e.g., tetrahydrofuran, or methyl tertiary butyl ether), or combinations thereof. The hydrophilic organic solvent is often anhydrous such as, for example, an anhydrous alcohol (e.g., anhydrous ethanol).

A method for exposing a hydrophilic organic solvent to a dried chromonic layer may include techniques, for example, die coating, dip coating, spray coating, knife coating, or curtain coating. Another technique for coating the hydrophilic organic solvent on the dried chromonic layer may include applying the hydrophilic organic solvent, as a liquid, drop wise onto the dried chromonic layer. With dip coating, the first electrode containing the dried chromonic layer can briefly be held in the hydrophilic organic solvent for a period of time of at least 1, at least 2, at least 3, or at least 4 seconds. The first electrode containing the dried chromonic layer can briefly be held in the hydrophilic organic solvent for a period of time up to 10, up to 9, up to 7, or up to 5 seconds. The first electrode containing the dried chromonic layer may be held in the hydrophilic organic solvent for a period of time in a range of 1 to 10 seconds, 2 to 9 seconds, 3 to 7, or 3 to 5 seconds. The hydrophilic organic solvent as a coating can be applied as a continuous or discontinuous coating layer to the dried chromonic layer to form a corresponding interconnected channel pattern within the dried chromonic layer. A discontinuous organic solvent coating may be applied in any desired pattern using any useful means such as, for example, inkjet coating or flexographic printing.

In some embodiments, heat may be applied to the hydrophilic organic solvent to vaporize the organic solvent. Heat can be applied in any useful manner such as, for example, in an oven, with hot air impingement, with infrared heaters, or through contact of the substrate with a heated surface such as a hot plate or a heated roll. Useful heating methods do not destroy the chromonic layer or warp the first electrode resulting in a dried chromonic layer.

Exposing the dried chromonic layer to a hydrophilic organic solvent can form a channel pattern. The channel pattern comprises a first set of channels and a second set of channels both within the dried chromonic layer. The first set of channels comprises a plurality of parallel or substantially parallel channels extending in the coating direction, and the second set of channels comprises a plurality of perpendicular or substantially perpendicular channels to the first set of channels. The first set of channels and the second set of channels may often have an average channel width of at least 10, at least 50, at least 100, or at least 250 nanometers. In some embodiments, the first set of channels and the second set of channels of the channel pattern can be formed having an average channel width up to 800, up to 700, up to 600, or up to 500 nanometers. The first set of channels and the second set of channels of the channel pattern can be formed having an average channel width in a range of 10 to 800 nanometers, 10 to 700 nanometers, 50 to 600 nanometers, or 100 to 500 nanometers. In one embodiment, the average channel width of the first set of channels may be generally similar to the average channel width of the second set of channels of the channel pattern.

Exposing the dried chromonic layer to a hydrophilic organic solvent forms a channel pattern comprising a first set of channels and a second set of channels each independently having an average channel depth equal to an average thickness of the dried chromonic layer. The surface of the first electrode may be exposed as a base for the first set of channels and the second set of channels. The first set of channels and the second set of channels each may be further defined by a chromonic material and surface modified inorganic nanoparticles as the recess surfaces or sidewalls extending perpendicular or substantially perpendicular to the surface of the first electrode. In some embodiments, the average channel depth of the first set of channels and the second set of channels of the channel pattern may be at least 50 nanometers, at least 75 nanometers, or at least 100 nanometers. The average depth of the channel pattern comprising the first set of channels and the second set of channels can be up to 2 micrometers, up to 1 micrometer, or up to 0.5 micrometers. The average channel depth of the channel pattern formed comprising the first set of channels and the second set of channels may be in a range of 50 nanometers to 2 micrometers, 200 nanometers to 2 micrometer, 200 nanometers to 1.5 micrometer, or 500 nanometers to 1.5 micrometers. In one embodiment, the average channel depth of the first set of channels may be generally similar to the average channel depth of the second set of channels.

Exposing the dried chromonic layer to a hydrophilic organic solvent forms a channel pattern comprising a first set of channels and a second set of channels each independently having an average period of at least 2 micrometers, at least 5 micrometers, at least 7 micrometers, or at least 10 micrometers. The term “period” being defined as the distance between nanostructures. In some embodiments, the channel pattern comprising a first set of channels and a second set of channels each independently may have an average period up to 20 micrometers, up to 18 micrometers, up to 15 micrometers, or up to 13 micrometers. The channel pattern comprising a first set of channels and a second set of channels each independently may have an average period in a range of 2 micrometers to 20 micrometers, 2 micrometers to 18 micrometers, 5 micrometers to 18 micrometers, 5 micrometers to 15 micrometers, or 7 micrometers to 13 micrometers. For example, a first channel and a second channel within the first set of channels may be separated from one another by a distance in a range of 2 micrometers to 20 micrometers. In one embodiment, the average period for the first set of channels may not be equal to the average period for the second set of channels within the dried chromonic layer. For example, the average period for the first set of channels is less than the average period for the second set of channels.

In one embodiment, a channel pattern may include a first set of channels having an average channel depth in a range from 50 nanometers to 2 micrometers, an average channel width in a range from 10 nanometers to 800 nanometers, and an average period in a range from 2 micrometers to 20 microns, and a second set of channels having an average channel depth in a range from 50 nanometers to 2 micrometers, an average channel width in a range from 10 nanometers to 800 nanometers, and an average period in a range from 2 micrometers to 20 microns. Some channel patterns may comprise a first set of channels and a second set of channels wherein each set of channels has an average channel depth in a range from 500 nanometers to 2 micrometers, an average channel width in a range of 100 nanometers to 300 nanometers, and an average period in a range from 3 micrometers to 10 micrometers.

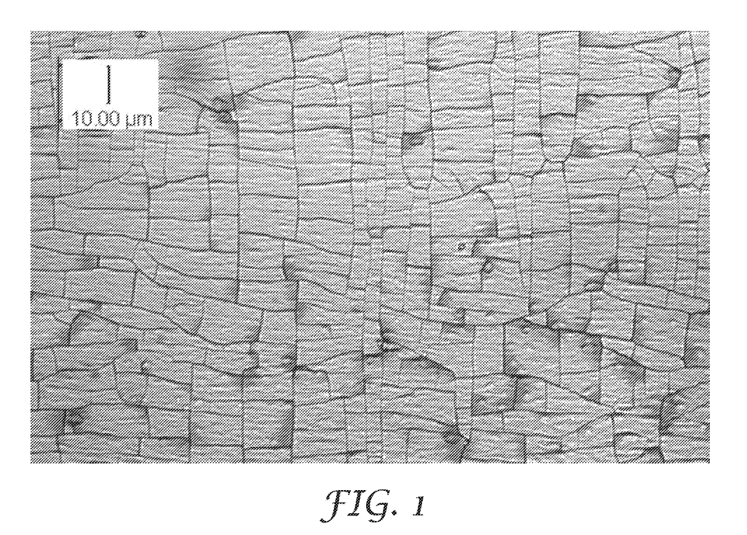

The channel pattern comprises channels having different lengths extending in a first direction (a coating direction) and a second direction (a direction substantially perpendicular to the coating direction). In one embodiment, the length of the channels of the first set of channels is greater than the length of the channels of the second set of channels. FIG. 1 illustrates a channel pattern having a first set of channels and a second set of channels deposited on the surface of the first electrode (i.e., conductive layer (i.e. ITO)).

The formation of channel patterns with chromonic molecules and surface modified inorganic nanoparticles may be accomplished with a single coating. A single coating for forming a channel pattern may be advantageous to a process that requires applying two separate and independent coatings to form interconnected channels oriented in two directions. Also, the single step application of a chromonic layer on the surface of a first electrode provides a method especially suited in a continuous, roll-to-roll process on a relatively large surface area providing for increased economic value.

A coupling agent known to react with metals or metal salts may be applied to a surface of the dried chromonic layer after the formation of the channel pattern and within the first set of channels and the second set of channels of the channel pattern. The coupling agent may be applied to the channel pattern. The coupling agent may be applied to the first and second set of channels and extending to the surface of the first electrode. One example of a coupling agent includes, but is not limited to, a thiol-containing silanol. A metal containing material may be applied on to the dried chromonic layer after treatment with the coupling agent.

In some embodiments, a first set of channels and a second set of channels of a channel pattern within a dried chromonic layer can be cleaned before a metal containing material is disposed within the channel pattern. The cleaning step can assist in improving adhesion, for example, of the metal containing material to the surface of the first electrode and within the channel pattern. Any useful cleaning process can be used to clean the first set of channels and the second set of channels within the dried chromonic layer that does not destroy the chromonic layer or warp the first electrode. Some useful cleaning processes include plasma treatment methods such as, for example, reactive ion etching, inductively coupled plasma, and the like.

A metal containing material can be disposed within the channel pattern to form a metallic channel pattern. The metal containing material within the channel pattern for forming the metallic channel pattern may be attached to the surface of the first electrode. Exemplary metal containing materials include, but are not limited to, metals, metal alloys, organometallic compounds, salts of metals, oxides of metals, or combinations thereof. The metal containing material may include a metal such as, for example, gold, silver, copper, titanium, iron, or platinum. In one embodiment, the metal may be gold. The metal containing material can include multiple layers of material such as multiple layers formed by sequentially depositing different metal containing materials. In another embodiment, the metal containing material has multiple metal layers that can be the same or different. The metal containing material may be a gold layer disposed on a titanium layer.

Different deposition techniques are available that can be used to apply a metal containing material. In some embodiments, metal containing materials such as metals can be deposited using vapor deposition techniques and the like. In other embodiments, metal containing materials can be applied using solution deposition techniques. For example, the metal containing material can be combined with a suitable solvent that does not disturb the integrity of the dried chromonic layer (e.g., the solvent does not dissolve the dried chromic layer). Metal containing materials may be deposited on to the dried chromonic layer, and within the channel pattern comprising a first set of channels and a second set of channels within the dried chromonic layer. The metal containing material can extend through the first and second sets of channels to be deposited on to the surface of the first electrode.

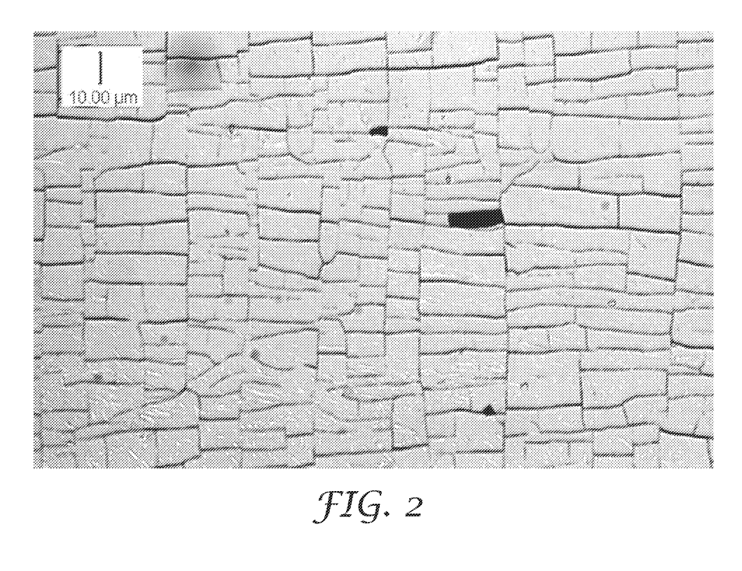

After the metal containing material has been disposed on a surface of the first electrode within the channel pattern, and on the surface of a dried chromonic layer, the dried chromonic layer may be removed. The dried chromonic layer, which includes the chromonic material and surface modified inorganic nanoparticles, can be removed from the substrate surface with a solvent that includes water. The metal containing material on the surface of the dried chromonic layer that is not within the channel pattern may also be removed. During this step, the metal containing material deposited within the first set of channels and the second set of channels typically remains attached to the surface of the first electrode. The remaining metal containing material attached to the surface of the first electrode may result in the formation of a conductive nanostructured grid. In one embodiment, the conductive nanostructured grid includes a first set of conductive nanostructures comprising a plurality of parallel or substantially parallel nanostructures, and a second set of conductive nanostructures perpendicular or substantially perpendicular to the first set of conductive nanostructures, where the first and second set of conductive nanostructures are interconnected. In some embodiments, the interconnected conductive nanostructured grid may conduct electricity. FIG. 2 illustrates a first conductive nanostructured grid having a first set of conductive nanostructures and a second set of conductive nanostructures deposited on a conductive layer (i.e. ITO). The conductive layer is part of a multilayer structure, such that the conductive layer is deposited on a flexible substrate.

Metal containing material that remains after removing both the dried chromonic layer and the metal containing material disposed on a surface of the dried chromonic layer may form a first conductive nanostructured grid. The first conductive nanostructured grid comprises a first set of conductive nanostructures and a second set of conductive nanostructures each independently having an average nanostructure width of at least 10 nanometers, at least 50 nanometers, at least 100 nanometers, or at least 250 nanometers. In some embodiments, the first set of conductive nanostructures and the second set of conductive nanostructures each independently may have an average nanostructure width up to 800 nanometers, up to 700 nanometers, up to 600 nanometers, or up to 500 nanometers. An average nanostructure width of the first set of conductive nanostructures and the second set of conductive nanostructures each independently may be in a range of 10 nanometers to 800 nanometers, 10 nanometers to 700 nanometers, 50 nanometers to 600 nanometers, or 100 nanometers to 500 nanometers.

The metal containing material of the first conductive nanostructured grid can have a first set of conductive nanostructures and a second set of conductive nanostructures forming a first conductive nanostructured grid each having an average nanostructure height of at least 10 nanometers, at least 75 nanometers, at least 85 nanometers, or at least 100 nanometers. In some embodiments, the average nanostructure height may be up to 2 micrometers, up to 1 micrometer, up to 0.75 micrometers or up to 0.5 micrometers. The nanostructures may have an average height in a range of 10 nanometers to 2 micrometers, 10 nanometers to 1 micrometer or 10 nanometers to 0.5 micrometers. The average conductive nanostructure height may be a function of the average particle size of the surface modified inorganic nanoparticles of the dried chromonic layer.

In one embodiment, the metal containing material may form metal conductive nanostructures having a first set of conductive nanostructures with a plurality of parallel or substantially parallel metal conductive nanostructures, and a second set of metal conductive nanostructures having a plurality of perpendicular or substantially perpendicular metal conductive nanostructures to the first set of metal conductive nanostructures. The first set of conductive nanostructures and the second set of conductive nanostructures each independently may have an average period of at least 2 micrometers, at least 5 micrometers, at least 7 micrometers, or at least 10 micrometers. The average period of the first set of conductive nanostructures and the second set of conductive nanostructures each independently may be up to 20 micrometers, up to 18 micrometers, up to 15 micrometers, or up to 13 micrometers. The average period of the first set of conductive nanostructures and the second set of conductive nanostructures each independently may be in a range of 2 micrometers to 20 micrometers, 2 micrometers to 18 micrometers, 5 micrometers to 15 micrometers, or 7 micrometers to 13 micrometers. In one embodiment, the first set of conductive nanostructures has an average period less than the average period for the second set of conductive nanostructures.

In some embodiments, the methods described herein can be used to form a first conductive nanostructured grid having a first set of conductive nanostructures and a second set of conductive nanostructures each independently having an average conductive nanostructure height in a range from 10 nanometers to 2 micrometers, an average conductive nanostructure width in a range from 10 nanometers to 800 nanometers, and an average period in a range from 2 micrometers to 20 micrometers. For example, the first set of conductive nanostructures and the second set of conductive nanostructures each independently have an average nanostructure height in a range of 10 nanometers to 1 micrometers, an average nanostructure width in a range of 100 nanometers to 300 nanometers, and an average period in a range from 3 micrometers to 10 micrometers. The dimensions of the first set of conductive nanostructures and the second set of conductive nanostructured each independently may provide for an optically transparent first electrode capable of conducting electricity. In some embodiments, the interconnected conductive nanostructured grids deposited on the surface of a first electrode have surface conductivity.

More specifically, a first electrode having multiple patterns of first and second conductive nanostructures for forming conductive nanostructured grids can be prepared from a single coating composition. A coating composition comprising chromonic material, surface modified inorganic nanoparticles, and water can be applied to a surface of a first electrode in a coating direction. After applying the coating composition, a portion of the water may be removed to form a dried chromonic layer. The dried chromonic layer can be exposed to a hydrophilic organic solvent to form a channel pattern. The channel pattern may comprise a first set of channels in the coating direction, and a second set of channels that are substantially perpendicular to the first set of channels. The first set of channels and the second set of channels have an average channel depth equal to an average thickness of the dried chromic layer. A metal containing material can then be disposed on the surface of the dried chromonic layer and within both the first set of channels and the second set of channels, where the metal containing material disposed within the first and second set of channels contacts the surface of the first electrode. Further, the dried chromonic layer and the metal containing material disposed on the surface of the dried chromonic layer can be removed. The metal containing material disposed within the first set of channels and the second set of channels can adhere to the surface of the first electrode. The metal containing material within the first set of channels and the second set of channels can form a first conductive nanostructured grid. The first conductive nanostructured grid comprises a first set of conductive nanostructures and a second set of conductive nanostructures. The second set of conductive nanostructures is substantially perpendicular to the first set of conductive nanostructures extending in the coating direction. This method further provides for a coating process for forming conductive nanostructures on a relatively large surface area.

In some embodiments, the channel pattern includes a first set of channels containing a plurality of parallel or substantially parallel channels extending in a coating direction, and a second set of channels which contains a plurality of perpendicular or substantially perpendicular channels to the first set of channels. The metal containing material of the first set of channels and the second set of channels contacts the surface of the first electrode.

An electro-responsive layer is positioned between a first electrode and a second electrode for making an electronic device. The electro-responsive layer faces the first conductive nanostructured grid deposited on a surface of the first electrode. Upon application of an external electrical current or an external electrical field in some instances, the electro-responsive layer may undergo an optical change such as emitting light or a change in the absorption of visible light, a physical change such as a change in size or molecular alignment, an electronic change such as changing energy levels, or a chemical change such as oxidation or reduction. In other instances, the physical or chemical changes of the electro-responsive layer may occur from factors such as temperature, force, or solvent. Some examples of electro-responsive layers include inorganic light emitting materials, organic light emitting materials, liquid crystal materials, electrochromic materials, electrophoretic materials or combinations thereof.

A light emitting material typically contains inorganic and/or organic electroluminescent materials. These materials include, but are not limited to, fluorescent or phosphorescent materials.

Inorganic light emitting materials commonly used in light emitting devices (LEDs) are generally based on p-n junctions having high internal quantum efficiencies. Examples of inorganic light emitting materials include, but are not limited to, GaPAs, AlGaInP, AlGaInN, GaInN, AlGaN, and combinations thereof. Inorganic light emitting material efficiencies can be greater than 50 percent for red LEDs, and lower light emitting efficiencies are possible at orange, amber, and yellow wavelengths. Inorganic light emitting materials are further described in Schubert, E. F.; Gessmann, T.; Kim, J. K., “Light-Emitting Diodes”; Kirk-Othmer Encyclopedia of Chemical Technology 5th ed., 14, 832-867 (2005), John Wiley & Sons, Inc.

Organic electroluminescent materials can include, for example, a small molecule (SM) emitter (e.g., a non-polymeric emitter), a SM doped polymer, a light-emitting polymer (LEP), a doped LEP, or a blended LEP. The organic electroluminescent material can be provided alone or in combination with any other organic or inorganic material that are functional or non-functional in an organic electroluminescent electronic device.

Light-emitting polymers (LEP)s are examples of electroluminescent materials. LEP materials are typically conjugated polymeric or oligomeric molecules that preferably have sufficient film-forming properties for solution processing. As used herein, “conjugated polymers or oligomeric molecules” refer to polymers or oligomers having a delocalized π-electron system along a polymer backbone. Such polymers or oligomers are generally semiconducting and can support positive and negative charge carriers along the polymeric or oligomeric chain.

Some examples of classes of suitable LEP materials include poly(phenylenevinylenes), poly(para-phenylenes), polyfluorenes, and copolymers or blends thereof. Suitable LEPs can also be molecularly doped, dispersed with fluorescent dyes or photoluminescent material, blended with active or non-active materials, or dispersed with active or non-active materials. LEP materials can be formed into a light-emitting structure, for example, by casting a solvent solution of the LEP material on the surface of a first or second electrode, or casting a solvent solution of the LEP material on to a first electrode containing a deposited first conductive nanostructured grid, and evaporating the solvent to produce a polymeric film. Alternatively, LEP material can be formed in situ on an electrode by the reaction of precursor species. Suitable methods for forming LEP layers are described in U.S. Pat. No. 5,408,109 (Heeger et al.). Other methods for forming light-emitting structures from LEP materials include, but are not limited to, laser thermal patterning, inkjet printing, screen printing, thermal head printing, photolithographic patterning, and extrusion coating. The light-emitting structure can include a single layer or multiple layers of LEP material or other electroluminescent materials.

The organic electroluminescent material can include one or more small molecule (SM) emitters. SM electroluminescent materials include charge transporting, charge blocking and semiconducting organic or organometallic compounds. Typically, SM materials can be vacuum deposited or coated from solution to form thin layers on an electrode of an electronic device. In practice, multiple layers of SM materials are typically used to produce efficient organic electroluminescent devices since a given material generally does not have both the desired charge transport and electroluminescent properties.

SM materials are generally non-polymeric organic or organometallic materials that can be used in organic electroluminescent lighting (OEL) displays and devices as emitter materials, charge transport materials, dopants in emitter layers (e.g., to control the emitted color), charge transport layers, and the like. Commonly used SM materials include N,N′-bis(3-methylphenyl)-N,N′-diphenylbenzidine (TPD) and metal chelate compounds such as tris(8-hydroxyquinoline) aluminum (AlQ).

Another example of electro-responsive materials includes electrochromic materials. Electrochromic materials generally change color when a charge is applied to a chemical species. These materials can undergo a color change depending on its redox state having distinct UV-visible absorption bands. Reversible electrochemical switching of the redox states can result in different colors. The optical change can be affected by a small electrical current operating at low direct current potential.

Generally, electrochromic materials include, but are not limited to ruthenium (II) complexes, polyanilines, polypyridyl complexes, viologens, and polyoxotungstates. Some electrochromoic materials have been described in U.S. Pat. Nos. 4,841,021 and 4,898,923 (Katritzky et al.) and U.S. Patent Application Publication 2007/0090326 (Bai et al.). Viologen and its derivatives can be represented by Formula XVII:

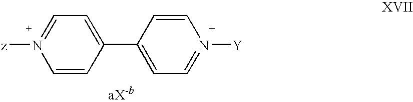

In Formula XVII, Z and Y may comprise phosphonyl groups, sulfonyl acid groups, or carboxy groups; a can be 1 or 2, and b is 1 or 2, such that aX^{-b} balances the charge of the two N⁺ in the rings. Electrochromic materials are further described in Samat, A. and Guglielmetti, R., “Chromogenic Materials”; Kirk-Othmer Encyclopedia of Chemical Technology, 5^{th} ed., 6, 571-587 (2004), John Wiley & Sons, Inc.

Other examples of electro-responsive materials include liquid crystal materials. Liquid crystal materials are substances having optical properties in the presence or absence of an external electric or magnetic field. The materials may be oriented or aligned with an applied electrical field, with an applied magnetic field, by applied shear, by choice of solvent, and by temperature for forming ordered structures. Liquid crystal materials are further described in Collings, P. J., “Liquid Crystalline Materials”; Kirk-Othmer Encyclopedia of Chemical Technology 5^{th} ed., 15, 81-120 (2005), John Wiley & Sons, Inc.

Liquid crystals (LC) can be divided into thermotropic and lyotropic LCs. Thermotropic LCs exhibit a phase transition into the liquid crystal phase when the temperature is changed, whereas lyotropic LCs exhibit phase transitions as a function of concentration of a mesogen (structural unit of LC) in a solvent (e.g., water) as well as temperature.

A liquid crystal material or molecule typically contains a rigid moiety (e.g., mesogen) and one or more flexible parts. The rigid part facilitates alignment of the molecules in one direction, whereas the flexible parts induce fluidity. This rigid part is referred to as mesogen. Liquid crystal materials are formed from a balance of the rigid and flexible parts.

Thermotropic liquid crystal materials include cholesteric liquid crystals. Cholesteric liquid crystal materials generally have molecular units that are chiral in nature and molecular units that are mesogenic in nature, and can also include polymers. Molecules with a cholesteric liquid crystal phase have a director (unit vector that specifies the direction of average local molecular alignment). The liquid crystal phase generally rotates in a helical fashion along a dimension perpendicular to the director.

Cholesteric liquid crystal compounds including cholesteric liquid crystal polymers are generally known. Examples of cholesteric liquid crystal compounds and polymers are further described in U.S. Pat. Nos. 4,293,435 (Portugall et al.); 5,332,522 (Chen et al.); 5,886,242 (Etzbach et al.); 5,847,068 (Maxein et al.); 5,780,629 (Etzbach et al.); and 5,744,057 (Meyer et al.).

An example of a cholesteric liquid crystal acrylate is represented by Formula XVIII:

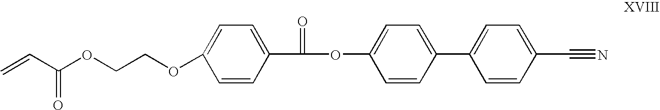

Formula XVIII can be prepared as described in EP 834754 (Motomura et al.). Some examples of commercially available cholesteric liquid crystals include those from BASF, Charlotte, N.C. under the trade designations PALIOCOLOR LC242 and PALIOCOLOR LC756.

Lyotropic liquid crystal materials generally include molecules having two distinct parts, which are called amphiphilic molecules. Amphiphilic molecules are materials contain a hydrophilic part and a hydrophobic part. In a solvent, these molecules tend to form phases having orientational order, positional order, or combinations thereof. These molecules tend to migrate to an interface in a polar liquid—slightly polar liquid or a polar liquid—nonpolar liquid mixture.

Electrophoretic materials are another example of electro-responsive materials. Electrophoretic materials can be used in electronic displays. These materials comprise micron-sized, electrically charged, colored particles that move toward or away from a viewing surface to display different images on a screen. The particles are generally suspended in a fluid or in a gas. As the electric potential in the pixels changes, varying amounts of black or white particles move to the display surface, showing colors of black, white, or tones of gray for a particular pixel.

A second electrode can be positioned adjacent to the electro-responsive layer of an electronic device. The second electrode is typically positioned opposite the first electrode of an electronic device. The second electrode is a conductive layer similar to that described for the first electrode. In one embodiment, the second electrode is a layer of a multilayer structure. The second electrode can be deposited on a substrate.

In one embodiment, a second conductive nanostructured grid can be provided on the surface of a second electrode. The second conductive nanostructured grid faces the electro-responsive layer of an electronic device. In another embodiment, the second conductive nanostructured grid may comprise the same or different metal containing material as the first conductive nanostructured grid. In further embodiment, the second conductive nanostructured grid may comprise the same or different conductive nanostructures (e.g., first and second) as the first conductive nanostructured grid.

The electro-responsive layer is positioned between the first electrode and the second electrode. The electro-responsive layer may be sandwiched between the first electrode and the second electrode for making an electronic device. In one embodiment, a first conductive nanostructured grid deposited on a surface of the first electrode faces the electro-responsive layer. In another embodiment, a second conductive nanostructured grid deposited on a surface of the second electrode faces the electro-responsive layer. The first and second electrodes may be sandwiched together under pressure (e.g., roller). The first electrode and the second electrode are generally aligned or in registration with one another for electrical connectivity across an electronic device.

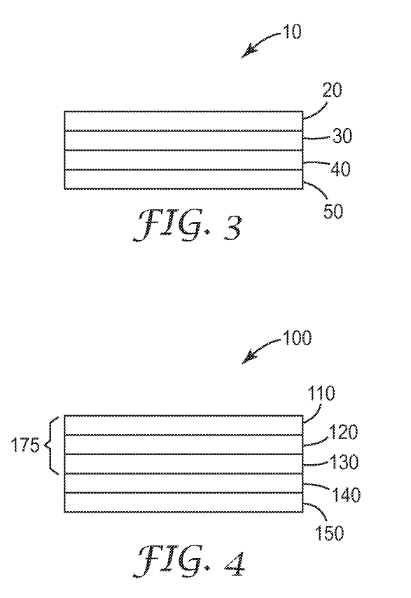

In one aspect, an electronic device 10 having a first conductive nanostructured grid 30 deposited on a surface of a first electrode 20 is formed. The electronic device 10 comprises a first electrode 20, an electro-responsive layer 40, and a second electrode 50. The electro-responsive layer 40 faces the first conductive nanostructured grid 30 deposited on the surface of the first electrode 20. The electro-responsive layer 40 is positioned between the first electrode 20 and the second electrode 50. The first conductive nanostructured grid 30 comprises a first set of conductive nanostructures and a second set of conductive nanostructures. The second set of conductive nanostructures is substantially perpendicular to the first set of conductive nanostructures. Electronic device 10 is illustrated in FIG. 3

In some embodiments, the first conductive nanostructured grid deposited on the first surface of the first electrode comprises a first set of conductive nanostructures and a second set of conductive nanostructures independently having an average thickness in a range of 50 nanometers to 2 micrometers. In other embodiments, the first conductive nanostructured grid may comprise a first set of conductive nanostructures and a second set of conductive nanostructures independently having an average width in a range of 10 nanometers to 800 nanometers. In further embodiments, the first conductive nanostructured grid may comprise a first set of conductive nanostructures and a second set of conductive nanostructures independently having an average period in a range of 2 micrometers to 20 micrometers.

In some embodiments, a reinforced electrode structure has an optical transmission of at least 70 percent of visible light (400-800 nm) transmitted through the reinforced electrode structure relative to the transmission of visible light transmitted through the first electrode without the first conductive nanostructured grid. The reinforced electrode structure compromises a first conductive nanostructured grid deposited on a first electrode. The nanometer sized dimensions of the first conductive nanostructured grid disposed on the first electrode generally allows for visible light to pass through the reinforced electrode structure. The reinforced electrode structure can be semi-transparent, or transparent. In one embodiment, the reinforced electrode structure may be part of a multilayer structure. The reinforced electrode structure can have an optical transmission of at least 75 percent, at least 80 percent, at least 85 percent, at least 90 percent, or at least 95 percent of the visible light transmitted through the reinforced electrode structure.

In some embodiments, a first set of conductive nanostructures and a second set of conductive nanostructures extend over at least 80 percent of the length and over at least 80 percent of the width of the first electrode. The first conductive nanostructured grid comprises the first set of conductive nanostructures and the second set of conductive nanostructures in which the first set and the second set of conductive nanostructures can be formed on a surface of a first electrode. The first conductive nanostructured grid has nanometer sized dimensions which can provide for a greater number of conductive nanostructures deposited across a surface of a first electrode. The greater number of conductive nanostructures can result in increased surface area coverage per square millimeter. The increased number of conductive nanostructures can provide for a larger number of contact points with an electro-responsive layer of an electronic device. The nanometer dimensions of the conductive nanostructures can provide for greater coverage on a surface of a first electrode. The first set of conductive nanostructures and a second set of conductive nanostructures can extend over at least 85 percent, at least 90 percent, or at least 95 percent of the length of the first electrode. The first set of conductive nanostructures and the second set of conductive nanostructures can extend over at least 85 percent, at least 90 percent, or at least 95 percent of the width of the first electrode.

In some embodiments, the first electrode comprises a conductive layer that is an outermost layer of a multilayer structure. The conductive layer may be applied to the surface of a substrate for making a multilayer structure. The substrate occasionally may be non-uniform. Non-uniform conductive layers can pose problems such as local defects resulting in electrical shorts when used in an electronic device. Some causes of shorting defects include, for example, particle contamination during deposition of the conductive layer onto the substrate, surface roughness often contributed from the substrate, and non-uniformities in the thickness of the electro-responsive layer. Local defects initially present as a result of fabrication imperfections are typically present as small non-emissive, non-conducting areas at the location of the electrical short. Shorting defects have been further described in U.S. Pat. No. 7,271,534 (Padiyath et al.).

Defects in a conductive layer can impose large deficiencies in electronic devices having large surface areas (e.g., televisions). Some substrates, for example, coated with a conductive layer of a multilayer structure can have local defects. Conductive nanostructured grids deposited on the surfaces of first electrodes may reduce the number of shorts or failures in electronic devices. The conductive nanostructured grids can provide a greater number of contact locations across the surface of the first electrode. The conductive nanostructured grid may perform as a continuous grid on the surface of a first electrode.

In one embodiment, the reinforced electrode structure comprises a first electrode in combination with a first conductive nanostructure grid. A first conductive nanostructured grid can be deposited on the surface of the first electrode. The reinforced electrode structure can be mechanically deformed and tested for surface conductivity. For example, reinforced electrode structures can be bent at a 90 degree angle over a steel mandrel having a diameter of 0.95 cm. The surface conductivity of the reinforced electrode structure can be measured to determine if any disruption in the continuity of the first electrode (e.g., ITO) has occurred. Samples of reinforced electrode structures bent at angles other than 90 degrees (e.g., 45 degrees) can be similarly evaluated for surface conductivity.

In one embodiment, a mechanically deformed reinforced electrode structure comprising the first electrode in combination with the first conductive nanostructured grid can have a surface conductivity of at least 70 percent after mechanically bending the reinforced electrode structure at least 6 times over a mandrel positioned at a 90 degree angle. The long axis of the mandrel is positioned perpendicular to the coating direction of the first conductive nanostructured grid deposited on the first electrode of the reinforced electrode structure. The reinforced electrode structure may retain a surface conductivity of at least 75 percent, at least 80 percent, at least 85 percent, at least 90 percent, or at least 95 percent after mechanically bending the reinforced electrode structure for at least 6 times at a 90 degree angle over a mandrel. Examples 1-4 exemplify the bending of a reinforced electrode structure having a first electrode in combination with a first conductive nanostructured grid.

In another embodiment, a second conductive nanostructured grid is deposited on a surface of a second electrode. The second conductive nanostructured grid is facing the electro-responsive layer in an electronic device. The second conductive nanostructured grid can have dimensions similar to the first conductive nanostructured grid deposited on the surface of the first electrode. In one embodiment, the second conductive nanostructured grid deposited on the surface of the second electrode has dimensions dissimilar to the dimensions of the first conductive nanostructured grid deposited on the surface of the first electrode.

Electronic devices having a reinforced electrode structure comprising a first electrode in combination with a first conductive nanostructured grid can be used in many applications. Some of these uses include backlighting, message signage, high and low resolution displays, and safety lighting. These electronic devices may be used with other components or materials such as polarizers, wave plates, touch panels, antireflective coatings, antismudge coatings, projection screens, brightness enhancement films, diffuser or other optical components, coatings, user interface devices, or the like.

In one aspect, a method for making an electronic device containing a substrate is described. A first electrode structure is formed comprising a substrate, a first conductive nanostructured grid and a conductive layer. The first conductive nanostructured grid is deposited on a surface of the substrate. The conductive layer is deposited on the first conductive nanostructured grid and on the surface of the substrate not covered by the first conductive nanostructured grid forming the first electrode structure. The conductive layer is deposited within the regions or spaces of the first conductive nanostructured grid which extend to the surface of the substrate. In one embodiment, the substrate is a non-conductive material. The substrate is capable of accepting the deposited first conductive nanostructured grid. The first electrode structure has a first conductive nanostructured grid deposited on a substrate rather than a first electrode. An electro-responsive layer faces the conductive layer of the first electrode structure rather than the first conductive nanostructured grid. The electro-responsive layer is positioned between the first electrode structure and the second electrode for forming an electronic device.

In another aspect, a method for making an electronic device is described. A first electrode structure is formed. A first conductive nanostructured grid is deposited on a surface of a substrate rather than on a first electrode. The first conductive nanostructured grid comprises a first set of conductive nanostructures and a second set of conductive nanostructures. The second set of conductive nanostructures is substantially perpendicular to the first set of conductive nanostructures. A conductive layer is deposited on the first conductive nanostructured grid and on the surface of the substrate to form a first electrode structure. The conductive layer is deposited between the region or spaces between the first set of conductive nanostructures and the second set of conductive nanostructures extending to the surface of the substrate. An electro-responsive layer faces the conductive layer of the first electrode structure rather than facing the first conductive nanostructured grid of another aspect of this disclosure. The electro-responsive layer is positioned between the first electrode structure and the second electrode.

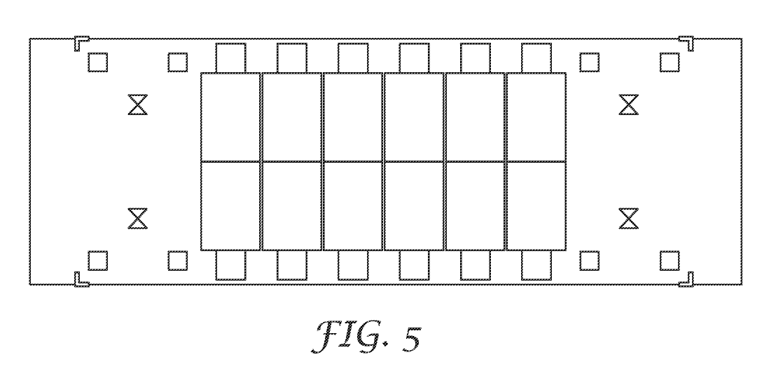

In another aspect, an electronic device 100 comprises a substrate 110, a first conductive nanostructured grid 120 deposited on a surface of the substrate 110, a conductive layer 130 deposited on the first conductive nanostructured grid 120 and the surface of the substrate 110, an electro-responsive layer 140 and a second electrode 150. An electronic device 100 is illustrated in FIG. 4. The first nanostructured grid 120 is deposited on a substrate 110, and the conductive layer 130 is deposited on the first conductive nanostructured grid 120 and the surface of the substrate 110 to form a first electrode structure 175. The electro-responsive layer 140 faces the conductive layer 130 rather than the first conductive nanostructured grid 120. The electro-responsive layer 140 is positioned between the first electrode structure 175 and the second electrode.

The disclosure will be further clarified by the following examples which are exemplary and not intended to limit the scope of the disclosure.

### EXAMPLES

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Preparatory Example 1

Surface modified inorganic nanoparticles were formed from the reaction of a silane with silica nanoparticles having an average diameter of 21 nanometers (nm). More specifically, 300 grams of Nalco 2327 colloidal silica available from Nalco Chemical Company of Naperville, Ill., was placed in a bottle equipped with a stir bar. While stirring, 28 grams of a 25 weight percent carboxyethyl silane triol sodium salt aqueous solution available from Gelest Inc. of Morrisville, Pa., were added to the colloidal silica over a period of 10 minutes. A small amount of precipitate formed upon the addition of the carboxyethyl silane triol sodium salt, but the precipitate dissolved with additional stirring. The clear dispersion was then placed in a 95° C. oven for 20 hours. The percent solids of the surface modified colloidal silica in water was determined to be 40 weight percent, based on weight loss after drying. The dispersion prior to drying was used in the subsequent examples.

### Preparatory Example 2

A mixture comprising 1.0 grams of starch (ICB 3000) available from Tate & Lyle PLC of Decatur, Ill., 12 grams of deionized water, 0.56 grams of a 30 weight percent aqueous ammonium hydroxide solution available from EMD Chemicals Inc. of Gibbstown, N.J., and 4.0 grams of the surface modified colloidal silica dispersion of Preparatory Example 1 was added to a container with mechanical stirring. After the dissolution of the starch in the mixture, 2.0 grams of the chromonic material of Formula III, (4-dimethylamino-1-[4,6-di(4-carboxyphenylamino)-1,3,5-triazin-2-yl]pyridinium chloride), was slowly added to the mixture with stirring. Upon dissolution of the chromonic material, 0.44 grams of a 10 weight percent aqueous solution of an alkyl polyglucoside surfactant (Glucopon 425N) from Cognis Corporation of Cincinnati, Ohio, was added to the mixture with stirring. The resulting mixture (20 grams total) was taken up by a disposable syringe fitted with a 5.0 micron disposable syringe filter (25 mm diameter with a Versapore Membrane—hydrophilic acrylic copolymer on a non-woven support; product #4489 from Pall Corporation, East Hills, N.Y.) and filtered. The resulting filtered mixture was transferred to a disposable syringe fitted with a 1.2 micron disposable syringe filter (25 mm diameter with a Versapore Membrane—hydrophilic acrylic copolymer on a non-woven support; product #4488 from Pall Corporation, East Hills, N.Y.) and filtered to form a coating composition.

The coating composition was coated on the adhesion promoting side of a poly(ethylene terephthalate) (PET) film (DuPont Teijin Films, Hopewell, Va. under the trade designation of Melinex ST504) that was cut into individual pieces having dimensions of 15.2 centimeter (cm) long×7.6 cm wide×0.013 cm thick. Prior to coating the PET film, each film was dry-etched using a YES G1000 Plasma Cleaning System available from Yield Engineering Systems Inc. of San Jose, Calif. The electrode configuration used was the “RIE Mode Arrangement” as found in “YES Plasma Cleaning System Manual 610-5237-01,” p. 3/12. The film was placed on one of the second, fourth, sixth, or eighth from the top electrodes (active). An O₂ etch plasma (charged via radio frequency (RF)) was used for 2 minutes.

The coating composition was applied to the film sample using a No. 2.5 wire wound drawdown bar available from UV Process Supply of Chicago, Ill., as a chromonic layer. The chromonic layer was allowed to air dry at about 25° C. for at least 5 minutes.

The sample was exposed by submersing the film in an aluminum baking pan having dimensions of approximately 32.5 cm×22.4 cm×3.2 cm available from Pactiv Corporation of Lake Forest, Ill. The aluminum baking pan was partially filled with absolute ethanol (200-proof) available from Aaper Alcohol & Chemical Company of Shelbyville, Ky. for approximately 10 seconds to induce the formation of a channel pattern. Exposure of the sample in the ethanol was performed by attaching a spring-loaded clip to each end of the sample to hold the sample under strain, and the sample was placed in an aluminum-baking pan containing the ethanol. The sample, under strain by the clips, was removed from the aluminum pan and allowed to drip for approximately one second before being held above a heat gun (Model: HG-301A “Master Heat Gun” Master Appliance Corp.; Racine, Wis.) fitted with an air diffuser (8 inch (20.3 cm) shrink packaging attachment, part no. 51024, Master Appliance Corp., Racine Wis.) to facilitate uniform temperature and drying over the sample area. The sample was held horizontally, lengthwise with the chromonic coated side up, at a distance of approximately 10 cm above the heat gun that was pre-heated at the lowest temperature setting (temperature switch set to position “II” with the air intake manifold fully open) until dry. The sample was passed horizontally through the hot air so that the leading edge was initially dried, and the sample continually moved across the hot air flow until the trailing edge was dry. The drying time was approximately 10 seconds.

After drying, the sample was inspected by optical microscopy, which showed a channel pattern on the PET film comprising a first set of channels and a second set of channels within the dried chromonic layer on the PET film.

The channel pattern of the dried chromonic layer on the film was subsequently dry-etched using a YES G1000 Plasma Cleaning System available from Yield Engineering Systems Inc. of San Jose, Calif. The electrode configuration used was the “RIE Mode Arrangement” as found in “YES Plasma Cleaning System Manual 610-5237-01,” p. 3/12. The film was placed on one of the second, fourth, sixth, or eighth from the top electrodes (active). An O₂ etch plasma (charged via radio frequency (RF)) was used for 4 minutes.

After etching, the film was placed in a metallization frame (face down) and held in place with a piece of aluminum foil tape (3M #425) available from 3M Company, St. Paul Minn. The dried chromonic layer on the film and the frame were placed in a high-vacuum metallization chamber. Once the chamber reached the appropriate vacuum pressure, approximately 5 nm of titanium was deposited on the surface of the dried chromonic layer, and within both the first set of channels and the second set of channels contacting the film (PET film) surface via electron-beam induced metal thermal evaporation. Next, approximately 100 nm of gold was deposited on the titanium layer via electro-thermal induced metal evaporation to form a bilayer metallic composition.

The bilayer metallic composition film was next submerged in approximately 750 milliliters (ml) of de-ionized water with approximately 15-20 drops of ammonium hydroxide (30 percent wt./wt.) available from EMD Chemicals Incorporated of Gibbstown, N.J., for approximately 2 hours to remove the chromonic material and the surface modified inorganic nanoparticles. The film was rinsed with de-ionized water to remove metal not attached to the film, and further disposed on the surface of the dried chromonic layer. Areas with excessive patches of disposed metal were given a secondary vigorous rinse with de-ionized water for several seconds. To remove debris from the sample, #810 Scotch Tape (3M Stationary Products Division, St. Paul, Minn.) was placed against the metallized side of the film (parallel to the coating direction), over regions to be cleaned. After a light hand pressure was applied to adhere the tape to the wires and film, the tape was then very slowly pulled off (−5 mm per second) in the opposite direction in which it was applied under a peel angle of approximately 180°.

Electrical surface conductivity of the resulting film containing the conductive nanostructured grid was determined to be 11.1 millisiemens/square, measured using a Delcom 717 non-contact eddy-current conductance monitor available from Delcom Instruments Inc. of Prescott, Wis.

### Preparatory Example 3

A second bimetallic nanowire-containing PET film was prepared using the procedure of Preparatory Example 2 having the same material concentrations, except that the resulting mixture was based on a total of 30 grams. Electrical surface conductivity of the resulting film was determined to be 22.1 millisiemens/square.

### Examples (Ex.) 1-4 and Comparative Examples C1-C6

A mixture comprising 13.0 grams of starch (ICB 3000) available from Tate & Lyle PLC of Decatur, Ill., 150 grams of deionized water, 8.2 grams of a 30 weight percent aqueous ammonium hydroxide solution available from EMD Chemicals Inc. of Gibbstown, N.J., and 50.0 grams of the surface modified colloidal silica dispersion of Preparatory Example 1 were added to a container with mechanical stirring. After the starch was dissolved in the mixture, 25 grams of the chromonic material of Formula III, (4-dimethylamino-1-[4,6-di(4-carboxyphenylamino)-1,3,5-triazin-2-yl]pyridinium chloride), was slowly added to the mixture with stirring. Upon dissolution of the chromonic material, 5.6 grams of a 10 weight percent aqueous solution of an alkyl polyglucoside surfactant (Glucopon 425N) from Cognis Corporation of Cincinnati, Ohio, was added to the mixture with stirring. The resulting mixture was taken up by a disposable syringe fitted with a 1.2 micron disposable syringe filter having a 25 millimeter (mm) diameter (Versapore Membrane #4488; hydrophilic acrylic copolymer on a nonwoven support) available from Pall Corporation of East Hills, N.Y., and filtered to form a coating composition.

The coating composition was coated on a poly(ethylene terephthalate) (PET) film (21.6 centimeter (cm) wide×0.013 cm thick) having a 100 ohms/square indium-tin-oxide (ITO) layer available from Techni-Met, Inc. Windsor, Conn. The coating composition was applied to the film using a No. 2.5 wire wound drawdown bar available from UV Process Supply of Chicago, Ill., as a chromonic layer. The chromonic layer was allowed to air dry at about 25° C. for approximately 15 minutes.

The film having a dried chromonic layer was cut into four samples. Each of the samples had dimensions of approximately 8 cm×22 cm. Each sample was exposed by submersing the film in an aluminum baking pan having dimensions of approximately 32.5 cm×22.4 cm×3.2 cm available from Pactiv Corporation of Lake Forest, Ill. The aluminum baking pan was partially filled with absolute ethanol (200-proof) available from Aaper Alcohol & Chemical Company of Shelbyville, Ky. for approximately 5 seconds to induce the formation of a channel pattern. The films were removed from the aluminum pan and shaken to remove standing ethanol, and then placed in an oven set at 110° C. for approximately 15 seconds to remove excess ethanol.

An optical micrograph representative of the samples FIG. 1 (500× magnification) shows a channel pattern on the ITO coated PET film comprising a first set of channels and a second set of channels within the dried chromonic layer on the ITO-coated PET film.

FIG. 1 shows that under the described conditions, the channel pattern comprises a first set of channels substantially aligned in the coating direction, and a second set of channels that are substantially perpendicular to the first set of channels. The first set of channels comprises a plurality of parallel or substantially parallel channels, where the length of the first set of channels is greater than a length of the second set of channels.

The channel pattern of the dried chromonic layer on each film was subsequently dry-etched using a YES G1000 Plasma Cleaning System available from Yield Engineering Systems Inc. of San Jose, Calif. The electrode configuration used was the “RIE Mode Arrangement” as found in “YES Plasma Cleaning System Manual 610-5237-01,” p. 3/12. The films were placed on the fourth from the top electrode (active). An O₂ etch plasma (charged via radio frequency (RF)) was used for 2 minutes.

After etching, the films were placed in a metallization frame (face down) and held in place with a piece of aluminum foil tape (3M #425) available from 3M Company, St. Paul Minn. The dried chromonic layer on the films and the frame were placed in a high-vacuum metallization chamber. Once the chamber reached the appropriate vacuum pressure, 5 nm of titanium was deposited on the surface of the dried chromonic layer, and within both the first set of channels and the second set of channels contacting the film (ITO-coated PET film) surface via electron-beam induced metal thermal evaporation. Next, 100 nm of gold was deposited on the titanium layer via electro-thermal induced metal evaporation to form a bilayer metallic composition.

The bilayer metallic composition films were next submerged in approximately 300 milliliters (ml) of de-ionized water with several drops of ammonium hydroxide (30 percent wt./wt.) available from EMD Chemicals Incorporate of Gibbstown, N.J., for approximately 2 hours to remove the chromonic material and the surface modified inorganic nanoparticles. Each of the films was rinsed with de-ionized water to remove metal not attached to the film, and further disposed on the surface of the dried chromonic layer. Areas with excessive patches of disposed metal were given a secondary vigorous rinse for several seconds. An optical micrograph representative of a film in FIG. 2 (500× magnification) shows a conductive nanostructured grid formed leaving the disposed metal within the first set of channels and the second set of channels, which adhered to the ITO coated PET film The two-dimensional conductive nanostructured grid comprises metal wires on the ITO-coated PET films.

Electrical surface conductivity of the films of Examples 1-4 was measured. As a control, six films (Comparative Examples C1-C6) of the 100 ohms/square ITO-coated PET substrate were cut to 8 cm×22 cm dimensions, and measured for electrical surface conductivity using a Delcom 717 non-contact eddy-current conductance monitor available from Delcom Instruments Inc. of Prescott, Wis.

After an initial measurement of electrical surface conductivity, each film of Examples 1-4 and Comparative Examples C1-C6 was mechanically deformed, six times, at a 90° bend over a steel mandrel (Bends 1-6 @ 90°). The mandrel had a diameter of 0.95 cm and was oriented perpendicular to the long axis of the films. Electrical surface conductivity (i.e., electrical surface conductance) (millisiemens/square) was measured after each pass over the mandrel.

After the sixth pass the samples were rinsed with de-ionized water, followed by a rinse with isopropanol, and allowed to air dry. After drying, each sample was mechanically deformed one time with the mandrel rotated such that the principal axis was oriented at an angle of 45° relative to the long axis of the film samples An additional 90° bend was performed using this configuration (Bend 7 @ 45°), followed by one additional 90° bend with the mandrel axis perpendicular to the long axis of the film (Bend 8 @ 90°). Surface conductivity was measured after each pass over the mandrel.

The films in Table 1 containing the conductive nanostructured grids (Examples 1-4) lost about 5-11% of their initial surface conductivity; whereas, the control samples (C1-C6) lost at least 96% of their initial surface conductivity.

TABLE 1
(Electrical Surface Conductance (mS/square))

| | | | | | | | | | | | Surface |
|---|---|---|---|---|---|---|---|---|---|---|---|
| | | Bend | Bend | Bend | Bend | Bend | Bend | Wash | Bend #7 | Bend | Conductivity |
| Ex. | Initial | #1 | #2 | #3 | #4 | #5 | #6 | Step | @ 45° | #8 | (% Change) |
| 1 | 18.4 | 18.5 | 18.8 | 18.1 | 18.0 | 18.3 | 18.1 | 17.6 | 17.2 | 17.5 | −4.9 |
| 2 | 15.6 | 15.4 | 15.3 | 15.1 | 15.2 | 14.9 | 15.2 | 14.7 | 14.2 | 14.2 | −9.0 |
| 3 | 21.6 | 21.5 | 20.3 | 20.8 | 20.4 | 20.4 | 20.3 | 20.4 | 19.2 | 19.2 | −11.1 |
| 4 | 24.8 | 24.1 | 24.1 | 24.1 | 24.4 | 24.2 | 24.2 | 23.0 | 22.6 | 22.8 | −8.1 |
| C1 | 9.62 | 9.44 | 6.47 | 1.54 | 0.82 | 0.65 | 0.66 | 0.61 | 1.43 | 0.31 | −96.8 |
| C2 | 9.67 | 4.75 | 0.42 | 0.24 | 0.16 | 0.12 | 0.11 | 0.16 | 0.85 | 0.03 | −99.7 |
| C3 | 9.66 | 9.44 | 5.84 | 1.08 | 0.38 | 0.32 | 0.21 | 0.22 | 0.77 | 0.12 | −98.8 |
| C4 | 9.62 | 5.37 | 0.53 | 0.26 | 0.18 | 0.14 | 0.12 | 0.14 | 0.94 | 0.05 | −99.5 |
| C5 | 9.64 | 7.13 | 1.48 | 0.30 | 0.19 | 0.15 | 0.12 | 0.16 | 1.02 | 0.04 | −99.6 |
| C6 | 9.66 | 4.77 | 0.48 | 0.34 | 0.21 | 0.14 | 0.11 | 0.13 | 0.70 | 0.05 | −99.5 |

### Examples 5A-5B and Comparative Example C7

A mixture comprising 5.21 grams of starch (ICB 3000) available from Tate & Lyle PLC of Decatur, Ill., 60 grams of deionized water, 2.64 grams of a 30 weight percent aqueous ammonium hydroxide solution available from EMD Chemicals Inc. of Gibbstown, N.J., and 20.00 grams of the surface modified colloidal silica dispersion of Preparatory Example 1 were added to a container with mechanical stirring. After the starch was dissolved in the mixture, 10.00 grams of the chromonic material of Formula III, (4-dimethylamino-1-[4,6-di(4-carboxyphenylamino)-1,3,5-triazin-2-yl]pyridinium chloride), was slowly added to the mixture with stirring. Upon dissolution of the chromonic material, 2.4 grams of a 10 weight percent aqueous solution of an alkyl polyglucoside surfactant (Glucopon 425N) available from Cognis Corporation of Cincinnati, Ohio was added to the mixture with stirring. The resulting mixture was taken up by a disposable syringe fitted with a 1.2 micron disposable syringe filter having a 25 millimeter (mm) diameter (Versapore Membrane #4488; hydrophilic acrylic copolymer on a nonwoven support) available from Pall Corporation of East Hills, N.Y., and filtered to form a coating composition.

The resulting solution was coated on a polyester (PET) film that contained a continuous, electrically conductive, indium-tin-oxide (ITO) coating. This substrate was 125 micron thickness ST-504 PET film available from Dupont Tejin, Japan, coated with ITO to give a surface resistance of 100 ohms/square available from Techni-Met, Inc. of Windsor, Conn. Coating of the films was performed using a #2.5 wire wound drawdown bar available from UV Supply of Chicago, Ill. The coated films (5A-5B) were allowed to air dry at room temperature at about 25° C. for approximately 15 minutes.

To induce channel production, Examples 5A and 5B were submerged in a thin, glass chamber (0.74×7.01×7.73 cm) filled with absolute, 200-proof ethanol (EtOH) available from Aaper Alcohol & Chemical Company of Shelbyville, Ky. for approximately 5 seconds. Examples 5A and 5B were removed from the glass chamber and given two or three vigorous shakes by hand to remove any pooled EtOH, and then placed into an oven (pre-heated to 100° C.) for approximately 15 seconds to remove excess ethanol.

Examples 5A and 5B were metallized using the procedure as described in Examples 1-4 and Comparative Examples C1-C6. Electrical surface resistance measurements of Examples 5A-5B having conductive nanostructured grids, and Comparative Example C7 (ITO coated PET without a conductive nanostructured grid) were performed on a Delcom 717 non-contact eddy current conductance monitor available from Delcom Instruments Inc. of Prescott Wis. Electrical surface resistance measurements in ohms/square are shown in the Table 2.

TABLE 2

| | Surface | Change in | Optical |
|---|---|---|---|
| | Resistance | Resistance | Transmission |
| Example | (Ω/square) | (%) | (% of control) |
| 5A | 68.2 | −33 | 90 |
| 5B | 65.6 | −35 | 93 |
| C7 | 101.7 | — | 100 |

An increase in surface conductivity and a small decrease in optical transmission was observed in Examples 5A-5B.

### Examples 6-7 and Comparative Examples C8-C10

Electrically switchable cholesteric liquid crystalline devices (i.e. electronic devices) comprising a cholesteric material (i.e. electro-responsive layer) sandwiched between ITO-containing conductive PET substrates were prepared.

As illustrated in FIG. 5, one electrode in each device contained 12 pixels of patterned ITO on a PET substrate. The substrates (i.e., pixelated substrates or pixilated electrodes) were obtained from 3M Touch Systems of Milwaukee, Wis. The pixilated substrates measured 14.2 cm×5.1 cm×0.013 cm, and contained a 12-pixel design of 200 ohms/square ITO-2 rows of 6 pixels (1.27 cm×1.91 cm), with each pixel containing an additional 0.64 cm square contact pad region that extended to the outer edge of the substrate.

### Examples 8-9 and Comparative Examples C11-C12

The bimetallic nanowire-containing film samples of Preparatory Example 2 and Preparatory Example 3 were placed in a metallization chamber (Mill Lane Engineering, Lowell, Mass.) under vacuum (1 millitorr) onto which a layer of indium tin oxide (ITO) was deposited through a sputtering process to give the films of Examples 8 and 9, respectively. For C11-C12, ITO was deposited on the adhesion promoting side of two pieces of poly(ethylene terephthalate) (PET) film (DuPont Teijin Films, Hopewell, Va. under the trade designation of Melinex ST504) having the dimensions of approximately 15.2 centimeter (cm) long×7.6 cm wide×0.013 cm thick.

Electrical surface conductivity of the film samples of Examples 8-9 and Comparative Examples C11-C12 were measured using a Delcom 717 non-contact eddy-current conductance monitor available from Delcom Instruments Inc. of Prescott, Wis.

After an initial measurement of electrical surface conductivity, each film of Examples 8-9 and Comparative Examples C11-C12 was mechanically deformed, six times, at a 90° bend over a steel mandrel (Bends 1-6 @ 90°). The mandrel had a diameter of 0.95 cm and was oriented perpendicular to the long axis of the films. Electrical surface conductivity (i.e., electrical surface conductance) (millisiemens/square) was measured after each pass over the mandrel.

After the sixth pass, each sample was mechanically deformed one time with the mandrel rotated such that the principal axis was oriented at an angle of 45° relative to the long axis of the film samples (Bend 7 @ 45°), followed by one additional 90° bend with the mandrel axis perpendicular to the long axis of the film (Bend 8 @ 90°). Surface conductivity was measured after each pass over the mandrel.

After the eighth pass, each sample was mechanically deformed one time with the mandrel rotated such that the principal axis was oriented at an angle of −45° relative to the long axis of the film samples (Bend 9 @ −45°), followed by one additional 90° bend with the mandrel axis perpendicular to the long axis of the film (Bend 10 @ 90°). Surface conductivity was measured after each pass over the mandrel.

After the tenth pass, each film was mechanically deformed at a 90° bend over a steel mandrel (Bend 11 @ 90°). The mandrel had a diameter of 0.64 cm and was oriented perpendicular to the long axis of the films. Electrical surface conductivity (i.e., electrical surface conductance) (millisiemens/square) was measured after each pass over the mandrel.

Films in Table 3 containing the conductive nanostructured grids (Examples 8-9) lost about 6-12% of their initial surface conductivity; whereas, C11 and C12 lost at least 85% of their initial surface conductivity.

TABLE 3
(Electrical Surface Conductance (mS/square))

| | | | | | | | | Bend | | Bend | | | Surface |
|---|---|---|---|---|---|---|---|---|---|---|---|---|---|
| | | Bend | Bend | Bend | Bend | Bend | Bend | #7 | Bend | #9 | Bend | Bend | Conductivity |
| Ex. | Initial | #1 | #2 | #3 | #4 | #5 | #6 | @ 45° | #8 | @ −45° | #10 | #11 | (% Change) |
| 8 | 41.8 | 39.3 | 39.1 | 38.7 | 38.7 | 38.8 | 38.5 | 38.7 | 37.7 | 38.0 | 37.1 | 37.0 | −11.5 |
| 9 | 45.8 | 43.8 | 43.8 | 44.3 | 44.5 | 44.5 | 44.5 | 43.8 | 44.0 | 43.9 | 43.1 | 42.9 | −6.3 |
| C11 | 15.4 | 15.8 | 12.9 | 8.9 | 6.0 | 4.4 | 3.5 | 12.6 | 3.6 | 12.1 | 1.9 | 1.1 | −92.9 |
| C12 | 19.7 | 17.2 | 14.0 | 11.6 | 9.7 | 9.9 | 8.2 | 17.9 | 8.3 | 16.8 | 4.5 | 2.8 | −85.8 |

### Pre-Polymer Solution

Methacryloxymethylphenyldimethylsilane (MMPDMS) 1.34 g, 67 wt. %)) available from Gelest Inc., of Morrisville, Pa., Elvacite 4059 (0.28 g, 14 wt. %) available from Lucite International Inc. of Cardova, Tenn., hexanediol dimethacrylate (HDDMA) 0.38 g, 19 wt. %)) Sartomer Company of Exton, Pa. were added to a vial fitted with a polytetrafluoroethylene (PTFE) seal. The vial was agitated on a shaker at room temperature for about 16 hours resulting in a clear solution. A photo-initiator (Irgacure 819) 0.03 g, 1.5 wt. % of pre-polymer mass) available from Ciba Specialty Chemicals, Tarrytown, N.Y. was added and shaken until the photo-initiator was dissolved.

### ChLC Coating Mixture

A cholesteric liquid crystal (ChLC) coating mixture was prepared by mixing 1.6 g of cholesteric liquid crystal (green mixture of 80 wt. % MDA-01-1955 and 20 wt. % MDA-00-3506) available from EMD Chemicals Inc. of Hawthorne, N.Y., 0.4 g of the pre-polymer solution prepared above and 0.03 g of a 3 um spacer beads (SP-203) from Sekisui of Japan. This mixture was sonicated with a Branson 2210 Ultrasonic Cleaner available from Branson Ultrasonic Corporation of Danbury, Conn. for 15 minutes.

### Electronic Device Preparation

A control cholesteric liquid display (i.e., Comparative Example C8) was prepared by sandwiching the cholestereric liquid crystal between two ITO-coated PET substrates. The first substrate was the pixelated substrate shown in FIG. 5, and the second substrate, used as a common electrode, was narrower and longer (3.7 cm×15.4 cm×0.013 cm) than the pixelated substrate, with a solid 200 ohms/square ITO layer.

The two substrates were put together with the ITO layers facing each other, with the common electrode centered such that the contact pads on the pixelated substrate were exposed. Between two substrates, a few drops of the ChLCD coating solution was dispensed using a pipette, and the construction was subsequently fed through a Laminex AV666 VSR laminator available from Laminex Inc. of Charlotte, N.C. Excess ChLC coating solution at the edges of the devices was cleaned with a methanol wipe. The electronic device was placed under 1.2 mW/cm² UV light (350 BL) available from Sylvania of Danvers, Mass. with the first electrode closest to the UV light, and was cured for 15 minutes to give a cholesteric liquid crystal display.

This process was repeated for forming Comparative Examples C9-C10, with the exception that the common electrodes used were 100 ohms/square ITO/PET substrates that went through the bending process (mechanical deformation); specifically Comparative Examples C2 and C5.

This process was repeated for forming Examples 6-7 with the exception that the common electrodes used were 100 ohms/square ITO/PET substrates containing the gold conductive nanostructured grid that went through the bending process (mechanical deformation); specifically, Examples 2 and 4 respectively. In order to prevent damage to the nanowire surface, any excess ChLC coating solution washed off with methanol. For Examples 6-7, the pixelated ITO-PET substrate was closest to the UV light in the curing chamber.

TABLE 4
(all pixels switched to reflective state)

| | | Conductive | | | |
|---|---|---|---|---|---|
| | Mechanical | Nanostructured | | Pixels | |
| | Deformation | Grid | Pixels | (partially | Pixels |
| Example | (Yes/No) | (Yes/No) | (switchable) | switchable) | (non-switchable |
| 6 | Yes | Yes | 12 | 0 | 0 |
| 7 | Yes | Yes | 12 | 0 | 0 |
| C8 | No | No | 12 | 0 | 0 |
| C9 | Yes | No | 8 | 2 | 2 |
| C10 | Yes | No | 2 | 1 | 9 |

Table 4 illustrates the results of electronic devices prepared with and without the conductive nanostructure grid. Comparative Examples C9-C10 showed complete failure of some pixels and only partial switching of others.

TABLE 5
(pixels at 45 hours at 85° C./85% RH).

| | | Conductive | | | |
|---|---|---|---|---|---|
| | Mechanical | Nanostructured | | Pixels | |
| | Deformation | Grid | Pixels | (partially | Pixels |
| Example | (Yes/No) | (Yes/No) | (switchable) | switchable) | (non-switchable |
| 6 | Yes | Yes | 11 | 0 | 1 |
| 7 | Yes | Yes | 12 | 0 | 0 |
| C8 | No | No | 12 | 0 | 0 |
| C9 | Yes | No | 0 | 0 | 12 |
| C10 | Yes | No | 0 | 0 | 12 |

In Table 5, Comparative Examples C9-C10 experienced complete failure before 45 hours, the time at which they were first monitored. Only one pixel failure was observed for Examples 6 and 7 combined.

After 426 hours at 85° C. and 85% relative humidity, Examples 6-7 and C8 showed a blue discoloration around the edges for the devices.

Various modifications and alterations of this disclosure will be apparent to those skilled in the art without departing from the scope and spirit of this disclosure, and it should be understood that this disclosure is not limited to the illustrative elements set forth herein.

1. A method of making an electronic device comprising:
providing a first electrode;
depositing a first conductive nanostructured grid on a surface of the first electrode, the depositing comprising
(a) applying a coating composition in a coating direction to the surface of the first electrode to form a chromonic layer, the coating composition comprising chromonic material, surface modified inorganic nanoparticles, and water;
(b) removing at least a portion of the water from the chromonic layer to form a dried chromonic layer;
(c) exposing the dried chromonic layer to a hydrophilic organic solvent forming a channel pattern within the dried chromonic layer, the channel pattern comprising (i) a first set of channels in the coating direction and (ii) a second set of channels that are substantially perpendicular to the first set of channels;
(d) disposing a metal containing material on a surface of the dried chromonic layer opposite the first electrode, and within both the first set of channels and the second set of channels, the metal containing material within the first set of channels and the second set of channels contacting the first electrode; and
(e) removing both the dried chromonic layer and the metal containing material disposed on the dried chromonic layer, wherein the metal containing material disposed within the first set of channels and the second set of channels adheres to the first electrode;
providing an electro-responsive layer facing the first conductive nanostructured grid;
providing a second electrode; and
positioning the electro-responsive layer between the first electrode and the second electrode.

2. The method of claim 1, wherein the first electrode comprises a conductive layer that is an outermost layer of a multilayer structure.

3. The method of any one of claims 1 to 2, wherein the conductive layer comprises indium tin oxide, fluorine doped tin oxide, aluminum doped tin oxide, zinc oxide or combinations thereof.

4. The method of any one of claims 1 to 3, wherein a second conductive nanostructured grid is deposited on a surface of the second electrode.

5. The method of any one of claims 1 to 4, wherein a second conductive nanostructured grid is facing the electro-responsive layer.

6. The method of any one of claims 1 to 5, wherein the metal containing material comprises a metal, a metal oxide, an organometallic compound, a salt of a metal, a metal alloy, or combinations thereof.

7. The method of any one of claims 1 to 6, wherein the electro-responsive layer comprises an inorganic light emitting material, an organic light emitting material, a liquid crystal material, an electrochromic material, or combinations thereof.

8. The method of any one of claims 1 to 7, wherein the metal containing material disposed within the first set of channels and the second set of channels independently has an average height in a range of 10 nanometers to 2 micrometers.

9. The method of any one of claims 1 to 8, wherein the metal containing material disposed within the first set of channels and the second set of channels independently has an average width in a range of 10 nanometers to 800 nanometers.

10. The method of any one of claims 1 to 9, wherein the metal containing material disposed within the first set of channels and the second set of channels independently has an average period in a range of 2 micrometers to 20 micrometers.

11-14. (canceled)

15. An electronic device comprising:
a first electrode;
a first conductive nanostructured grid deposited on a surface of the first electrode, the first conductive nanostructured grid comprising a first set of conductive nanostructures and a second set of conductive nanostructures, the second set of conductive nanostructures substantially perpendicular to the first set of conductive nanostructures;
an electro-responsive layer facing the first conductive nanostructured grid; and
a second electrode;
wherein the electro-responsive layer is positioned between the first electrode and the second electrode.

16. The electronic device of claim 15, wherein a reinforced electrode structure comprising the first electrode in combination with the first conductive nanostructured grid has an optical transmission of at least 70 percent.

17. The electronic device of any one of claims 15 to 16, wherein a reinforced electrode structure comprising the first electrode in combination with the first conductive nanostructured grid retains a surface conductivity of at least 70 percent after mechanically bending the reinforced electrode structure at least 6 times at a 90 degree angle over a mandrel.

18. The electronic device of any one of claims 15 to 17, wherein the first set of conductive nanostructures and the second set of conductive nanostructures distributed over at least 80 percent of the length and over at least 80 percent of the width of the first electrode.

19. The electronic device of any one of claims 15 to 18, wherein the first set of conductive nanostructures and the second set of conductive nanostructures independently have an average height in a range of 10 nanometers to 2 micrometers.

20. The electronic device of any one of claims 15 to 19, wherein the first set of conductive nanostructures and the second set of conductive nanostructures independently have an average width in a range of 10 nanometers to 800 nanometers.

21. The electronic device of any one of claims 15 to 20, wherein the first set of conductive nanostructures and the second set of conductive nanostructures independently have an average period in a range of 2 micrometers to 20 micrometers.

22. The electronic device of any one of claims 15 to 21, wherein a second conductive nanostructured grid is deposited on a surface of the second electrode.

23. The electronic device of any one of claims 15 to 22, wherein a second conductive nanostructured grid is facing the electro-responsive layer.

24. A method of making an electronic device comprising:
providing a substrate;
depositing a first conductive nanostructured grid on a surface of the substrate, the depositing comprising
(a) applying a coating composition in a coating direction to the surface of the substrate to form a chromonic layer, the coating composition comprising chromonic material, surface modified inorganic nanoparticles, and water;
(b) removing at least a portion of the water from the chromonic layer to form a dried chromonic layer;
(c) exposing the dried chromonic layer to a hydrophilic organic solvent forming a channel pattern within the dried chromonic layer, the channel pattern comprising
(i) a first set of channels in the coating direction and (ii) a second set of channels that are substantially perpendicular to the first set of channels;
(d) disposing a metal containing material on a surface of the dried chromonic layer opposite the substrate, and within both the first set of channels and the second set of channels, the metal containing material within the first set of channels and the second set of channels contacting the substrate; and
(e) removing both the dried chromonic layer and the metal containing material disposed on the dried chromonic layer, wherein the metal containing material disposed within the first set of channels and the second set of channels adheres to the substrate;
depositing a conductive layer on the first conductive nanostructured grid and on the surface of the substrate forming a first electrode structure;
providing an electro-responsive layer facing the conductive layer of the first electrode structure;
providing a second electrode; and
positioning the electro-responsive layer between the first electrode structure and the second electrode.

25. (canceled)

26. An electronic device comprising:
a substrate;
a first conductive nanostructured grid deposited on a surface of the substrate, the first conductive nanostructured grid comprising a first set of conductive nanostructures and a second set of conductive nanostructures, the second set of conductive nanostructures substantially perpendicular to the first set of conductive nanostructures;
a conductive layer deposited on the first conductive nanostructured grid and on the surface of the substrate of a first electrode structure;
an electro-responsive layer facing the conductive layer of the first electrode structure; and
a second electrode;
wherein the electro-responsive layer is positioned between the first electrode structure and the second electrode.
